(19) United States
(12) Patent Application Publication
(10) Pub. No.: US 2026/0277325 A1
(43) Pub. Date: Sep. 17, 2026

(54) Method and Apparatus for Non-Invasive Brain-Machine Interface

(71) Applicant: Thaddeus Gabara, Murray Hill, NJ (US)

(72) Inventor: Thaddeus Gabara, Murray Hill, NJ (US)

(73) Assignee: Thaddeus Gabara, Murray Hill, NJ (US)

(21) Appl. No.: 19/385,463

(22) Filed: Nov. 11, 2025

Related U.S. Application Data
(60) Provisional application No. 63/719,136, filed on Nov. 12, 2024.

(51) Int. Cl. G06F 3/01

(52) U.S. Cl. CPC G06F 3/015

(57) ABSTRACT

An information signal amplitude modulates a high frequency carrier wave signal which is wirelessly delivered to the brain. At least one axon in a brain captures the wireless signal by optimally matching the carrier wave wavelength to the length of the axon which acts as an antenna to receive signal. The axon-synapse structure behaves as a low pass filter and filters out the high frequency carrier wave from the signal leaving the information signal. The axon-synapse structure behaves as a demodulator and passes the filtered information signal to a coupled neuron to stimulate and activate said neuron.

### RELATED APPLICATIONS

The present patent application claims the benefit and priority of the filing date under 35 U.S.C. 119 (e) of Provisional U.S. Patent Application Ser. No. 63/719,136, filed Nov. 12, 2024, entitled METHOD AND APPARATUS FOR NON-INVASIVE BRAIN-MACHINE INTERFACE, which is hereby incorporated by reference in their entirety.

### BACKGROUND OF THE INVENTION

FIG. 1 depicts “the vertebrate cerebrum (brain) formed by two cerebral hemispheres that are separated by a groove, the longitudinal fissure. The brain can thus be described as being divided into left and right cerebral hemispheres. Each of these hemispheres has an outer layer of grey matter, the cerebral cortex that is supported by an inner layer of white matter”, (from https://en.wikipedia.org/wiki/Cerebral_hemisphere.) Note that the outer layer of the cerebral cortex is folded. For example, the groves of the central sulcus and lateral fissure are pointed out locating where their folds exist. Regions controlling motor functions, visual functions, auditory functions are also indicated and mapped out.

Note that in the white dotted box 1-3 a region highlighting a region 1-1 is presented. This region illustrates a lateral portion of the lateral fissure. Shortly, a side-view of this lateral fissure will be presented as indicated by the direction of the arrow 1-2.

“The cerebral cortex, also known as the cerebral mantle, is the outer layer of neural tissue of the cerebrum of the brain in humans and other mammals. It is the largest site of neural integration in the central nervous system, and plays a key role in attention, perception, awareness, thought, memory, language, and consciousness. The cerebral cortex is the part of the brain responsible for cognition. The six-layered neocortex makes up approximately 90% of the cortex, with the allocortex making up the remainder. The cortex is divided into left and right parts by the longitudinal fissure, which separates the two cerebral hemispheres that are joined beneath the cortex by the corpus callosum. In most mammals, apart from small mammals that have small brains, the cerebral cortex is folded, providing a greater surface area in the confined volume of the cranium. Apart from minimizing brain and cranial volume, cortical folding is crucial for the brain circuitry and its functional organization. In mammals with small brains, there is no folding and the cortex is smooth. A fold or ridge in the cortex is termed a gyrus (plural gyri) and a groove is termed a sulcus (plural sulci, see FIG. 1). These surface convolutions appear during fetal development and continue to mature after birth through the process of gyrification. In the human brain, the majority of the cerebral cortex is not visible from the outside, but buried in the sulci. The major sulci and gyri mark the divisions of the cerebrum into the lobes of the brain. The four major lobes are the frontal, parietal, occipital and temporal lobes. Other lobes are the limbic lobe, and the insular cortex often referred to as the insular lobe. These neurons are organized into horizontal cortical layers, and radially into cortical columns and minicolumns. Cortical areas have specific functions such as movement in the motor cortex, and sight in the visual cortex (indicated in FIG. 1). The motor cortex is primarily located in the precentral gyrus, and the visual cortex is located in the occipital lobe”, (from https://en.wikipedia.org/wiki/Cerebral_cortex). FIG. 1 highlights the dashed rectangular region 1-3. Within this region is a portion of the lateral fissure 1-1. Later, a side-view 1-2 will be presented of the internal components of the brain matter within the region of 1-1.

FIG. 2. illustrates “a neuron or nerve cell, and is an excitable cell that fires electric signals called action potentials across a neural network in the nervous system. The human brain has some 8.6×10\hat{ }10 (eighty six billion) neurons. Each neuron has on average 7,000 synaptic connections to other neurons. Neurons communicate with other cells via synapses, which are specialized connections that commonly use minute amounts of chemical neurotransmitters to pass the electric signal from the presynaptic neuron to the target cell through the synaptic gap. Synapses can be excitatory or inhibitory, either increasing or decreasing activity in the target neuron, respectively. Some neurons also communicate via electrical synapses, which are direct, electrically conductive junctions between cells. Neurons are typically classified into three types based on their function: sensory, motor, and interneurons. Sensory neurons respond to stimuli such as touch, sound, or light that affect the cells of the sensory organs, and they send signals to the spinal cord or brain. Motor neurons receive signals from the brain and spinal cord to control everything from muscle contractions to glandular output. Interneurons connect neurons to other neurons within the same region of the brain or spinal cord. When multiple neurons are functionally connected together, they form what is called a neural circuit. Most neurons receive signals via the dendrites and soma and send out signals down the axon. At the majority of synapses, signals cross from the axon of one neuron to the dendrite of another. However, synapses can connect an axon to another axon or a dendrite to another dendrite. The signaling process is partly electrical and partly chemical. Neurons are electrically excitable, due to the maintenance of voltage gradients across their membranes. If the voltage changes by a large enough amount over a short interval, the neuron generates an all-or-nothing electrochemical pulse called an action potential. This potential travels rapidly along the axon and activates synaptic connections as it reaches them. Synaptic signals may be excitatory or inhibitory, increasing or reducing the net voltage that reaches the soma,” (from https://en.wikipedia.org/wiki/Neuron). The action potential is an information signal that can be used to activate a neuron.

“In humans, the cerebral cortex contains approximately 14-16 billion neurons, and the estimated number of neurons in the cerebellum is 55-70 billion. Each neuron is connected by synapses to several thousand other neurons, typically communicating with one another via root-like protrusions called dendrites and long fiber-like extensions called axons, (see FIG. 2) which are usually myelinated and carry trains of rapid micro-electric signal pulses called action potentials to target specific recipient cells in other areas of the brain or distant parts of the body. The prefrontal cortex, which controls executive functions, is particularly well developed in humans. The operations of individual brain cells are now understood in considerable detail but the way they cooperate in ensembles of millions is yet to be solved. Recent models in modern neuroscience treat the brain as a biological computer, very different in mechanism from a digital computer, but similar in the sense that it acquires information from the surrounding world, stores it, and processes it in a variety of ways. Axons transmit signals to other neurons by means of specialized junctions called synapses, (see inset photo, FIG. 2). A single axon may make as many as several thousand synaptic connections with other cells. When an action potential, traveling along an axon, arrives at a synapse, it causes a chemical called a neurotransmitter to be released. The neurotransmitter binds to receptor molecules in the membrane of the target cell,” (from https://en.wikipedia.org/wiki/Brain). The action potential is an information signal that through the gap of the synapse the neurotransmitter is applied as input to a neuron via the receptor to activate the neuron.

“Brain cells make up the functional tissue of the brain. The two main types of cells in the brain are neurons (See FIG. 2), also known as nerve cells, and glial cells (See FIG. 8), also known as neuroglia. In FIG. 2, neurons are the excitable cells of the brain that function by communicating with other neurons and interneurons (via synapses), in neural circuits and larger brain networks. The two main neuronal classes in the cerebral cortex are excitatory projection neurons and inhibitory interneurons. Neurons are often grouped into a cluster known as a nucleus where they usually have roughly similar connections and functions. Nuclei are connected to other nuclei by tracts of white matter,” (from https://en.wikipedia.org/wiki/Brain_cell). The white mater lies below the outer grey matter of the brain.

FIG. 3A illustrates a transverse section through the gray matter of the cerebral cortex which is about 2-3 mm thick, and the axons carrying the current tend to be perpendicular to the cortical surface and these axons have a straight line component. Thus, the electrical current flow in these axons would be perpendicular to the its surface. However, as mentioned earlier, the cerebral cortex is folded in various regions, for example, as was earlier illustrated in FIG. 1, two examples are near the cerebral sulcus and lateral fissure. At these folds, a cross-sectional view of the cerebral cortex would see the axons lying parallel to the surface of the page. Thus, the electrical current flowing in these axons would be lengthwise to the page. The electrical fields cause by the flowing charges in the axons would generate an electric field that surrounds the axon and propagates away from it and towards the reader.

FIG. 3B illustrates the side view 1-2 of the lateral fissure 1-1 as indicated by the arrow 1-2 illustrated in FIG. 1. This presents the cross-sectional view of the white 3-1 and grey 3-2 matter of the cerebral cortex folding within the gap or fissure 3-3. The white matter is about 2 mm thick and contains two different orientational types of neurons coupled to axons or dendrites. The first set comprises the neuron 3-4 and its axon 3-5. Note that these axons have a straight line component and are perpendicular to the surface of the brain 3-10. The second set comprises the neuron 3-6 and its axon 3-7 and note that these axons also have a straight line component and are parallel to the surface of the brain 3-10. In addition, the axons 3-9 and 3-11 are illustrated.

The arrow 3-8 presents the top-view of FIG. 3B and is illustrated in FIG. 3C showing the fissure 3-3 sideways. From this perspective, only the neuron 3-4 (from the first set) is visible as its axon is behind the neuron and is in-line with the neuron. However, the neuron 3-6 (from the second set) and its axon 3-7 is lying horizontally or parallel to the surface of the brain 3-10. In addition, the axons 3-9 and 3-11 of FIG. 3B are also lying horizontally in FIG. 3C. These three axons will be used and discussed later in the present disclosure. Thus, since the white matter 3-1 of the brain makes a fold at the fissure 3-3. The neurons and their axons have different orientations to that of the surface of the brain 3-10 depending on whether they are found before the fold (perpendicular to the surface) or after the fold (parallel to the surface).

Some of the axons 3-7, 3-9, and 3-11 may extend into the white matter of the brain. Once in the white region, the axon's path may change. It may be possible that some of these axons can develop a dog leg (right angle) as they pass through a fold or near a fold due to the nature of the fold itself. Thus, some axons may contain two lengths of axons that are at right angles to each other.

FIG. 4 presents “myelin is a lipid-rich material that surrounds nerve cell axons (the nervous system's electrical wires) to insulate them and increase the rate at which electrical impulses (called action potentials) pass along the axon. The myelinated axon can be likened to an electrical wire (the axon) with insulating material (myelin) around it. However, unlike the plastic covering on an electrical wire, myelin does not form a single long sheath over the entire length of the axon. Rather, myelin ensheaths the axon segmentally: in general, each axon is encased in multiple long sheaths with short gaps between, called nodes of Ranvier. At the nodes of Ranvier, which are approximately one thousandth of a mm in length, the axon's membrane is bare of myelin. Myelin's best known function is to increase the rate at which information, encoded as electrical charges, passes along the axon's length. Myelin achieves this by eliciting saltatory conduction. Saltatory conduction refers to the fact that electrical impulses ‘jump’ along the axon, over long myelin sheaths, from one node of Ranvier to the next. Thus, information is passed around 100 times faster along a myelinated axon than a non-myelinated one,” (from https://en.wikipedia.org/wiki/Myelin). The length of the myelin sheath on the axon is about 1 mm while the gap between the myelin sheaths (the nodes of Ranvier) is about 1 um in length. The blow-up insert illustrates the construction of the axon encased by the myelin sheath. The inner axon comprises the microtubule and microfilament.

“In neuroscience, saltatory conduction (See FIG. 5) is the propagation of action potentials along myelinated axons from one node of Ranvier to the next node, increasing the conduction velocity of action potentials. The uninsulated nodes of Ranvier are the only places along the axon where ions are exchanged across the axon membrane, regenerating the action potential between regions of the axon that are insulated by myelin, unlike electrical conduction in a simple circuit. Myelinated axons only allow action potentials to occur at the unmyelinated nodes of Ranvier that occur between the myelinated internodes. It is by this restriction that saltatory conduction propagates an action potential along the axon of a neuron at rates significantly higher than would be possible in unmyelinated axons (150 m/s compared from 0.5 to 10 m/s). As sodium rushes into the node it creates an electrical force which pushes on the ions already inside the axon. This rapid conduction of electrical signal reaches the next node and creates another action potential, thus refreshing the signal. In this manner, saltatory conduction allows electrical nerve signals to be propagated long distances at high rates without any degradation of the signal. Although the action potential appears to jump along the axon, this phenomenon is actually just the rapid conduction of the signal inside the myelinated portion of the axon. If the entire surface of an axon were insulated, action potentials could not be regenerated along the axon resulting in signal degradation,” (from https://en.wikipedia.org/wiki/Saltatory_conduction). The cross-section of the myelinated axon sheath 5-1 is shown in the upper left and the region is called neurilemmal. This was also illustrated in the inset of FIG. 4. Ion action due to open and closed ion channels only occur before and after the myelinated axons within the 1 um gap as illustrated in 5-2 as to where the action potential occurs. The sheath is about 1 mm long. The neuron is connected to the axon via the axon hillock and also shows connections to dendrites.

In FIG. 6: (a) the circle, is a Sodium (Nat) ion; (b) the triangle, is a Potassium (K+) ion; (c) is a Sodium channel; (d) is a Potassium channel; and (e) is a Sodium-Potassium Pump and occurs along the axon of the neuron. “In the stages of an action potential, the permeability of the membrane of the neuron changes. At the resting state (1), sodium and potassium ions are unable to pass through the membrane, and the neuron has a negative charge inside (mainly due to the large proteins that are negatively charged, as well as the lower amount of positive K+ ions inside the neuron). Once the action potential is triggered, the depolarization (2) of the neuron activates the sodium channel, allowing sodium ions to pass through the membrane of the neuron and results in a positive charge in the neuron and a negative charge in the extracellular fluid. After the action potential is reached, the neuron begins repolarization (3), where the sodium channels close and the potassium channels open, allowing potassium ions to cross the membrane and flood into the extracellular fluid, resulting in a positive charge in the extracellular fluid and a negative charge that is below the resting potential of the neuron. Finally, the membrane potential returns to the resting state as the potassium channels close during the refractory period (4). The sodium-potassium pump works to maintain the concentration gradient over time by exchanging three sodium ions per two potassium ions across the plasma membrane”, (from https://en.wikipedia.org/wiki/Action_potential). In the inset, the voltage waveform of the action potential is illustrated during the phases of (1), (2), (3), and (4). The voltage waveform of the action potential is an information signal. This action potential only occurs in the uninsulated nodes of Ranvier formed along a myelinated axonas described in FIG. 4 and FIG. 5. However, in an unmyelinated axon, the action potential occurs in sequential segments along the axon's length causing a slower propagation and more loss to occur to the signal.

FIG. 7 illustrates “the Hodgkin-Huxley model, or conductance-based model, is a mathematical model that describes how action potentials in neurons are initiated and propagated. It is a set of nonlinear differential equations that approximates the electrical engineering characteristics of excitable cells such as neurons and muscle cells. It is a continuous-time dynamical system. The typical Hodgkin-Huxley model treats each component of an excitable cell as an electrical element (as shown in the FIG. 6). The lipid bilayer is represented as a capacitance (Cₘ). Voltage-gated ion channels are represented by electrical conductances (gₙ). where n is the specific ion channel) that depend on both voltage and time. Leak channels are represented by linear conductances (g_{L}). The electrochemical gradients driving the flow of ions are represented by voltage sources (Eₙ) whose voltages are determined by the ratio of the intra- and extracellular concentrations of the ionic species of interest. Finally, ion pumps are represented by current sources (Iₚ). The membrane potential is denoted by Vₘ.

Mathematically, the current flowing through the lipid bilayer is written as

$${I}_{c} = {C}_{m} \frac{{dV}_{m}}{dx} \qquad ( 1 )$$

and the current through a given ion channel is the product of that channel's conductance and the driving potential for the specific ion

$${I}_{i} = {g}_{i} ( {V}_{m} - {V}_{i} ) \qquad ( 2 )$$

where Vᵢ is the reversal potential of the specific ion channel. Thus, for a cell with sodium and potassium channels, the total current through the membrane is given by:

$$I = {C}_{m} \frac{d y}{d x} + {g}_{K} ( {V}_{m} - {V}_{K} ) + {g}_{N a} ( {V}_{m} - {V}_{N a} ) + {g}_{l} ( {V}_{m} - {V}_{l} ) \qquad ( 3 )$$

where I is the total membrane current per unit area, Cₘ is the membrane capacitance per unit area, g_{K} and g_{Na} are the potassium and sodium conductances per unit area, respectively, V_{K} and V_{Na} are the potassium and sodium reversal potentials, respectively, and grand Viare the leak conductance per unit area and leak reversal potential, respectively. The time dependent elements of this equation are Vₘ, g_{Na}, and g_{K}, where the last two conductances depend explicitly on the membrane voltage (Vₘ) as well. In order to arrive at the complete solution for a propagated action potential, one must write the current term I on the left-hand side of the first differential equation in terms of V, so that the equation becomes an equation for voltage alone. The relation between I and V can be derived from cable theory and is given by

$$I = \frac{a}{2 R} \frac{{\partial }^{2} V}{\partial {x}^{2}} \qquad ( 4 )$$

where a is the radius of the axon, R is the specific resistance of the axoplasm, and x is the position along the nerve fiber. Substitution of this expression for I transforms the original set of equations into a set of partial differential equations, because the voltage becomes a function of both x and t,” (from https://en.wikipedia.org/wiki/Hodgkin % E2%80%93Huxley_model).

“Axoplasm is the cytoplasm within the axon of a neuron (nerve cell). For some neuronal types this can be more than 99% of the total cytoplasm. Axoplasm has a different composition of organelles and other materials than that found in the neuron's cell body (soma) or dendrites. In axonal transport (also known as axoplasmic transport) materials are carried through the axoplasm to or from the soma. The electrical resistance of the axoplasm, called axoplasmic resistance, is one aspect of a neuron's cable properties, because it affects the rate of travel of an action potential down an axon. If the axoplasm contains many molecules that are not electrically conductive, it will slow the travel of the potential because it will cause more ions to flow across the axolemma (the axon's membrane) than through the axoplasm. Axoplasm is integral to the overall function of neurons in propagating action potential through the axon. The amount of axoplasm in the axon is important to the cable like properties of the axon in cable theory. In regards to cable theory, the axoplasmic content determines the resistance of the axon to a potential change. The composing cytoskeletal elements of axoplasm, neural filaments, and microtubules provide the framework for axonal transport which allows for neurotransmitters to reach the synapse. Furthermore, axoplasm contains the pre-synaptic vesicles of neurotransmitter which released into the are eventually synaptic cleft,” (from https://en.wikipedia.org/wiki/Axoplasm).

A description of cable theory is presented next as extracted from https://en.wikipedia.org/wiki/Cable_theory, “In neuroscience, classical cable theory uses mathematical models to calculate the electric current (and accompanying voltage) along passive neurites, particularly the dendrites that receive synaptic inputs at different sites and times, (See FIG. 8). Estimates are made by modeling dendrites and axons as cylinders composed of segments with capacitances cₘ and resistances rₘ combined in parallel. The capacitance of a neuronal fiber comes about because electrostatic forces are acting through the very thin lipid bilayer. The resistance in series along the fiber rₗ is due to the axoplasm's significant resistance to movement of electric charge. Note, various conventions of rₘ exist. Here rₘ and cₘ, as introduced above, are measured per membrane-length unit (per meter (m)). Thus rₘ is measured in ohm·meters (Ω·m) and cm in farads per meter (F/m). This is in contrast to Rₘ (in Ω·m²) and Cₘ (in F/m²), which represent the specific resistance and capacitance respectively of one unit area of membrane (in m²). Thus, if the radius, a, of the axon is known, then its circumference is 2πa, and its rₘ, and its cₘ values can be calculated as:

$${r}_{m} = \frac{{R}_{m}}{2 π a} \qquad ( 5 )$$

$${c}_{m} = {C}_{m} 2 π a \qquad ( 6 )$$

These relationships make sense intuitively, because the greater the circumference of the axon, the greater the area for charge to escape through its membrane, and therefore the lower the membrane resistance (dividing Rₘ by 2πa); and the more membrane available to store charge (multiplying Cₘ by 2πa). The specific electrical resistance, ρₗ, of the axoplasm allows one to calculate the longitudinal intracellular resistance per unit length, rₗ, (in Ω·m−1) by the equation:

$${r}_{l} = \frac{{ρ}_{l}}{π {a}^{2}} \qquad ( 7 )$$

The greater the cross sectional area of the axon, πa², the greater the number of paths for the charge to flow through its axoplasm, and the lower the axoplasmic resistance. Several important avenues of extending classical cable theory have recently seen the introduction of endogenous structures in order to analyze the effects of protein polarization within dendrites and different synaptic input distributions over the dendritic surface of a neuron. To better understand how the cable equation is derived, first simplify the theoretical neuron even further and pretend it has a perfectly sealed membrane (rₘ=∞) with no loss of current to the outside, and no capacitance (cₘ=0). A current injected into the fiber at position x=0 would move along the inside of the fiber unchanged. Moving away from the point of injection and by using Ohm's law (V=IR) we can calculate the voltage change as:

$$Δ V = - {i}_{r} {r}_{l} Δ x \qquad ( 8 )$$

where the negative is because current flows down the potential gradient. Letting Δx go towards zero and having infinitely small increments of x, one can write (8) as:

$$\frac{\partial V}{\partial x} = - {i}_{l} {r}_{l} \qquad ( 9 )$$

$$or$$

$$\frac{1}{{r}_{l}} \frac{\partial V}{\partial x} = - {i}_{l} \qquad ( 10 )$$

Bringing rₘ back into the picture is like making holes in a garden hose. The more holes, the faster the water will escape from the hose, and the less water will travel all the way from the beginning of the hose to the end. Similarly, in an axon, some of the current traveling longitudinally through the axoplasm will escape through the membrane. If iₘ is the current escaping through the membrane per length unit, m, then the total current escaping along y units must be y·iₘ. Thus, the change of current in the axoplasm, Δiₗ, at distance, Δx, from position x=0 can be written as:

$$Δ {i}_{l} = - {i}_{m} Δ x \qquad ( 11 )$$

or, using continuous, infinitesimally small increments:

$$\frac{\partial {i}_{l}}{\partial x} = - {i}_{m} \qquad ( 12 )$$

iₘ can be expressed with yet another formula, by including the capacitance. The capacitance will cause a flow of charge (a current) towards the membrane on the side of the cytoplasm. This current is usually referred to as displacement current (here denoted i_{c}.) The flow will only take place as long as the membrane's storage capacity has not been reached. i_{c} can then be expressed as:

$${i}_{c} = {c}_{m} \frac{\partial V}{\partial t} \qquad ( 13 )$$

where cₘ is the membrane's capacitance and

$$\frac{\partial V}{\partial t}$$

is the change in voltage over time. The current that passes the membrane (iᵣ) can be expressed as:

$${i}_{r} = \frac{V}{{r}_{m}} \qquad ( 14 )$$

and because iₘ=iᵣ+i_{c} the following equation for iₘ can be derived if no additional current is added from an electrode:

$$\frac{\partial {i}_{l}}{\partial x} = - {i}_{m} = \frac{V}{{r}_{m}} + {c}_{m} \frac{\partial V}{\partial t} \qquad ( 15 )$$

where

$$\frac{\partial {i}_{l}}{\partial x}$$

represents the change per unit length of the longitudinal current.

Combining equations (10) and (15) gives a first version of a cable equation:

$$\frac{1}{{r}_{i}} \frac{{\partial }^{2} V}{\partial {x}^{2}} = {c}_{m} \frac{\partial y}{\partial x} + \frac{V}{{r}_{m}} \qquad ( 16 )$$

which is a second-order partial differential equation (PDE). By a simple rearrangement of equation (16) (see later) it is possible to make two important terms appear, namely the length constant (sometimes referred to as the space constant) denoted λ and the time constant denoted t. The following sections focus on these terms. The length constant, λ, is a parameter that indicates how far a stationary current will influence the voltage along the cable. The larger the value of λ, the farther the charge will flow. The length constant can be expressed as:

$$λ = \sqrt{\frac{{r}_{m}}{{r}_{l}}} \qquad ( 17 )$$

The larger the membrane resistance, rₘ, the greater the value of λ, and the more current will remain inside the axoplasm to travel longitudinally through the axon. The higher the axoplasmic resistance, rₗ, the smaller the value of λ, the harder it will be for current to travel through the axoplasm, and the shorter the current will be able to travel. It is possible to solve equation (13) and arrive at the following equation (which is valid in steady-state conditions, i.e. when time approaches infinity):

$${V}_{x} = {V}_{0} {e}^{- \frac{x}{λ}} \qquad ( 18 )$$

Where V₀ is the depolarization at x=0 (point of current injection), e is the exponential constant (approximate value 2.71828) and Vₓ is the voltage at a given distance x from x=0. When x=λ then

$$\frac{x}{λ} = 1 \qquad ( 19 )$$

$$and$$

$${V}_{x} = {V}_{0} {e}^{- 1} \qquad ( 20 )$$

which means that when we measure V at distance λ from x=0 we get

$${V}_{λ} = \frac{{V}_{0}}{e} = 0.369 {V}_{0} \qquad ( 21 )$$

Thus V_{λ} is always 36.8 percent of V₀. Neuroscientists are often interested in knowing how fast the membrane potential, Vₘ, of an axon changes in response to changes in the current injected into the axoplasm. The time constant, τ, is an index that provides information about that value. τ can be calculated as:

$$τ = {r}_{m} {c}_{m} \qquad ( 22 )$$

The larger the membrane capacitance, cₘ, the more current it takes to charge and discharge a patch of membrane and the longer this process will take. The larger the membrane resistance rₘ, the harder it is for a current to induce a change in membrane potential. So the higher the τ, the slower the nerve impulse can travel. That means, membrane potential (voltage across the membrane) lags more behind current injections. Response times vary from 1-2 milliseconds in neurons that are processing information that needs high temporal precision to 100 milliseconds or longer. A typical response time is around 20 milliseconds. If one multiplies equation (16) by rₘ on both sides of the equal sign we get:

$$\frac{{r}_{m}}{{r}_{i}} \frac{{\partial }^{2} V}{\partial {x}^{2}} = {c}_{m} {r}_{m} \frac{\partial V}{\partial t} + V \qquad ( 23 )$$

and recognize

$${λ}^{2} = \frac{{r}_{m}}{{r}_{l}}$$

on the left side and τ=cₘrₘ on the right side. The cable equation can now be written in its perhaps best known form:

$${λ}^{2} \frac{{\partial }^{2} V}{\partial {x}^{2}} = τ \frac{\partial V}{\partial t} + V \qquad ( 24 )$$

This is a 1D heat equation or diffusion equation for which many solution methods, such as Green's functions and Fourier methods, have been developed. It is also a special degenerate case of the Telegrapher's equation, where the inductance L vanishes and the signal propagation speed

$$\frac{1}{\sqrt{LC}}$$

is infinite, (from https://en.wikipedia.org/wiki/Cable_theory).

“Brain cells make up the functional tissue of the brain. The two main types of cells in the brain are neurons, also known as nerve cells, and glial cells, also known as neuroglia. Neurons are the excitable cells of the brain that function by communicating with other neurons and interneurons (via synapses), in neural circuits and larger brain networks. The two main neuronal classes in the cerebral cortex are excitatory projection neurons and inhibitory interneurons. Neurons are often grouped into a cluster known as a nucleus where they usually have roughly similar connections and functions. Nuclei are connected to other nuclei by tracts of white matter,” (from https://en.wikipedia.org/wiki/Brain_cell).

FIG. 9 illustrates the “three types of glial cells are astrocytes, oligodendrocytes, and ependymal cells, known collectively as macroglia, and the smaller scavenger cells known as microglia. Glia are grouped into macroglia-astrocytes, ependymal cells, and oligodendrocytes, and much smaller microglia which are the macrophages of the central nervous system. Astrocytes are seen to be capable of communication with neurons involving a signaling process similar to neurotransmission called gliotransmission. Glial stem cells are found in all parts of the adult brain. Glial cells greatly outnumber neurons and apart from their supporting role to neurons, glia-astrocytes in particular have been acknowledged as being able to communicate with neurons involving a signaling process similar to neurotransmission called gliotransmission. They cannot produce an action potential as generated by a neuron but in their large numbers they can produce chemicals expressing excitability that exert an influence on neural circuitry. The star-like shape of the astrocyte allows contact with a great many synapses. Glia are the supporting cells of the neurons and have many functions not all of which are clearly understood, but include providing support and nutrients to the neurons. Astrocytes are seen to be capable of communication with neurons involving a signaling process similar to neurotransmission called gliotransmission,” (from https://en.wikipedia.org/wiki/Brain_cell).

“Classical electrophysiology techniques involve placing electrodes into various preparations of biological tissue. Electrophysiology is the branch of physiology that studies the electrical properties of biological cells and tissues. In neuroscience, it includes measurements of the electrical activity of neurons, and, in particular, action potential activity. Recordings of large-scale electric signals from the nervous system, such as electroencephalography (EEG), may also be referred to as electrophysiological recordings.” The voltage clamp technique allows an experimenter to “clamp” the cell potential at a chosen value. This makes it possible to measure how much ionic current crosses a cell's membrane at any given voltage. This is important because many of the ion channels in the membrane of a neuron are voltage-gated ion channels, which open only when the membrane voltage is within a certain range. Voltage clamp measurements of current are made possible by the near-simultaneous digital subtraction of transient capacitive currents that pass as the recording electrode and cell membrane are charged to alter the cell's potential. Current clamp is not to be confused with Current clamp in electronics. The current clamp technique records the membrane potential by injecting current into a cell through the recording electrode. Unlike in the voltage clamp mode, where the membrane potential is held at a level determined by the experimenter, in “current clamp” mode the membrane potential is free to vary (See FIG. 10A), and the amplifier records whatever voltage the cell generates on its own or as a result of stimulation. This is a whole-cell current clamp recording of a neuron firing due to its being depolarized by current injection. This technique is used to study how a cell responds when electric current enters a cell; this is important for instance for understanding how neurons respond to neurotransmitters that act by opening membrane ion channels,” (from https://en.wikipedia.org/wiki/Electrophysiology).

“The brain's electrical charge is maintained by billions of neurons. Neurons are electrically charged (or “polarized”) by membrane transport proteins that pump ions across their membranes as depicted in FIG. 6. Neurons are constantly exchanging ions with the extracellular milieu, for example to maintain resting potential and to propagate action potentials. Ions of similar charge repel each other, and when many ions are pushed out of many neurons at the same time, they can push their neighbors, who push their neighbors, and so on, in a wave. This process is known as volume conduction. When the wave of ions reaches the electrodes on the scalp, they can push or pull electrons on the metal in the electrodes. Since metal conducts the push and pull of electrons easily, the difference in push or pull voltages between any two electrodes can be measured by a voltmeter. Recording these voltages over time gives us the EEG. The electric potential generated by an individual neuron is far too small to be picked up by EEG or MEG. EEG activity therefore always reflects the summation of the synchronous activity of thousands or millions of neurons that have similar spatial orientation. If the cells do not have similar spatial orientation, their ions do not line up and create waves to be detected. Pyramidal neurons of the cortex are thought to produce the most EEG signal because they are well-aligned and fire together. Because voltage field gradients fall off with the square of distance, activity from deep sources is more difficult to detect than currents near the skull. In conventional scalp EEG, the recording is obtained by placing electrodes on the scalp with a conductive gel or paste, usually after preparing the scalp area by light abrasion to reduce impedance due to dead skin cells. Many systems typically use electrodes, each of which is attached to an individual wire “, (from https://en.wikipedia.org/wiki/Electroencephalography).

The measured brain wave signals range in frequencies from 0.1 to more than 100 Hz. There are beta waves (13 to 25) and gamma waves (25 to 60 Hz) waves. These are associated with cognitive activity. The slower waves: theta (4 to 8 Hz) and delta waves (1 to 4 Hz) are associated with a state of sleep.

FIG. 10B illustrates the nerve network extending from the brain to the extremities of the body. The axons or the fibers carrying the nerve's signal to and from the brain comprises of axons that can be 1 meter in length. The sense of feel transfers from the skin of the entire body back to the brain. In addition, signals from the brain travel along this communication system to move muscles.

Understanding the complex operation of the brain is currently underway using a variety of tools. As illustrated in FIG. 11, the various regions of the brain have been mapped to our five senses of sight, touch, feel, hearing, and taste. For example, the somatic sensory involves interpreting the sensory information from the body's skin, joints and muscles. Other regions include motor functions such as the movement of arms and legs, while still other regions have mapped where the production and speech occurs and where understanding speech occurs. The outer region of the brain is called the cerebral cortex and is folded. One example of electrode placement (a non-invasive method) measures some of these brain signals on a human subject as illustrated in FIG. 12.

Information about the brain has also been measured using a technique called electrophysiology which is an invasive technology. In order to get physically to the brain, a hole has to be drilled through the skull. Then thin needles are inserted into the brain to get this information. This information includes measurement of voltage or current changes in neurons. Performing such activates can potentially damage the brain.

“Invasive Brain-Computer Interface (BCI) requires surgery to implant electrodes under the scalp for accessing brain signals. The main advantage is to increase accuracy. Invasive BCIs involve electrodes that penetrate brain tissue in an attempt to record action potential signals (also known as spikes) from individual, or small groups of, neurons near the electrode. While intracellular recordings of neurons reveal action potential voltages on the scale of hundreds of millivolts, chronic invasive BCIs rely on recording extracellular voltages which typically are three orders of magnitude smaller, existing at hundreds of microvolts. Partially invasive BCI devices are implanted inside the skull but rest outside the brain rather than within the grey matter. Electronic limitations to invasive BCIs have been an active area of research in recent decades. While intracellular recordings of neurons reveal action potential voltages on the scale of hundreds of millivolts, chronic invasive BCIs rely on recording extracellular voltages which typically are three orders of magnitude smaller, existing at hundreds of microvolts. Further adding to the challenge of detecting signals on the scale of microvolts is the fact that the electrode-tissue interface has a high capacitance at small voltages. Due to the nature of these small signals, for BCI systems that incorporate functionality onto an integrated circuit, each electrode requires its own amplifier and ADC, which convert analog extracellular voltages into digital signals. Because a typical neuron action potential lasts for one millisecond, BCIs measuring spikes must have sampling rates ranging from 300 Hz to 5 kHz. Yet another concern is that invasive BCIs must be low-power, so as to dissipate less heat to surrounding tissue; at the most basic level more power is traditionally needed to optimize signal-to-noise ratio. Human experiments have used non-invasive neuroimaging interfaces. The majority of published BCI research involves noninvasive EEG-based BCIs. EEG-based technologies and interfaces have been used for the broadest variety of applications. Although EEG-based interfaces are easy to wear and do not require surgery, they have relatively poor spatial resolution and cannot effectively use higher-frequency signals because the skull interferes, dispersing and blurring the electromagnetic waves created by the neurons”, (from https://en.wikipedia.org/wiki/Brain % E2%80%93computer_interface). Non-invasive methods are preferred to simplify access to the brain.

One non-invasive technique measures the high frequency emission of the brain. A Russian team discovered a previously unknown microwave electromagnetic radiation emitting from the brain. Their patent is entitled “METHOD FOR REGISTRATION OF HUMAN BRAIN ELECTROMAGNETIC ACTIVITY” by Andrey S. Bryukhovetskiy, RU2017126117A, filed Jul. 20, 2017. Their abstract states “The method of recording the amplitude-frequency characteristics (AFC) of weak electromagnetic waves (SEMV) of the human brain (UHF) in the range of ultrahigh (UHF) and ultrahigh (UHF) frequencies, including transcranial examination of the brain by recording the SEMV GM using log-periodic UHF/UHF antennas with a built-in low-noise amplifier, the receiving part of which is located in the immediate vicinity of the examined brain region of the test subject's skull, and the determination of the frequency response of the EMW using a highly sensitive spectrum analyzer UHF/SHF bands with low phase noise eigenvectors and connected to the antenna output through the RF cable, and registration of GM sEMV performed when the at least shielded anechoic test chamber and antenna. 2. The method according to p. 1, characterized in that the determination of the frequency response of the EMW is carried out when the specified spectrum analyzer and radio frequency cable are located in an anechoic shielded chamber. 3. The method according to p. 1 or 2, characterized in that as an anechoic shielded camera using a camera with a shielding factor of at least 80 dB.”

Recently, as stated in “Progress in Brain Research” Volume 258, 2020, Pages 51-75, the same authors Andrey S. Bryukhovetskiy, et. al. describe their discovery as “a previously unknown microwave electromagnetic radiation of the EHF/UHF range (from 1.5 GHz to 4.5 GHz) with signal strength of −130 dBm . . . 100 dBm (1e-15 . . . 1e-13 W) emitting from the brain. The detected electromagnetic waves have zonal variations in the different areas of the human head and are absent in other areas of the human body. The method of recording of the microwave electromagnetic activity of the human brain is patented in the Russian Federation. The microwave electromagnetic activity of the brain is billion-fold different from the bioelectric activity recorded by the encephalography.”

Thus, currently there appears to be two ranges of frequencies of electrical signals being emitted from the brain: A) 0.1 to 100 Hz; and B) 1.5 Ghz to 4.5 Ghz. Applicant believes that there are other methods, ways, and apparatus to read and utilize the brain's high frequency signals of the B) range.

### BRIEF SUMMARY OF THE INVENTION

One of the inventive embodiments of this invention is using antenna arrays to detect the near-field GHz signals that the brain is emitting. The antenna array would be electronically focused to search different regions of the brain and do so in a sequential manner. For example, in one embodiment, the observed point in the brain is scanned across a first row, then the observed point is moved to the second row along the last column and scanned back across this second row until the first column, dropping to the third row and repeating the sequence again until a particular region of the brain has been measured. The measurements during this sequential ordering, in one embodiment, would monitor the brain when the human body is repetitively exercising a movement of, for example, the finger. In another embodiment, the measurements would record the brain signals when the human is in thought of a dream situation. These signals that are emitted from the brain are captured by the antenna array.

In another embodiment, the receiving antenna array would be rotated to align the electric field produced by the axons to with the antenna structure of the array until a maximum transfer is received by the antenna elements. In one embodiment, simple antennas such as dipoles, monopoles and loops may be used in the antenna array. These antenna elements optimally resonate at the carrier wave frequency of the received carrier wave signal or optimally resonate when the output of the power amplifier driven by a modulated carrier wave frequency is coupled to the antenna. For example, a half-wave dipole comprises two ¼ wavelength segments. At 3 GHZ, each ¼ wavelength segment would be about 2.5 cm in length. The wavelength of the carrier wave frequency at 3 GHz would be 10 cm. In one embodiment, a wavelength of a carrier wave is optimized to match a length of an antenna can mean that the 3 GHz carrier wave matches the ¼ wavelength of a dipole (2.5 cm) or that the 3 GHz carrier wave matches the ½ wavelength of a both sections of the dipole (5 cm). In another embodiment, a wavelength of a carrier wave is optimized to match a length of an antenna can mean that the 3 GHz carrier wave matches the full wavelength of a whip antenna (10 cm). In yet another embodiment, a wavelength of a carrier wave is optimized to match a length of an antenna can mean that a maximum power is transferred from the source (amplifier) to the destination (said antenna). As the frequency of the carrier wave decreases, the wavelength increases and vice versa. At higher frequencies, because of the shorter length antennas, more antennas can be packed into a given area of the antenna array. This can be beneficial since a larger frequency bandwidth can be sent or captured out of this given area. This larger bandwidth allows for a greater amount of information transfer.

In one embodiment, delays are applied to the received signals according to the distance between the point being observed and physical location of the particular antenna in the array. That is, the most distant path is used as a reference length, and then all remaining signals are adjusted until their equivalent length is the same as the most distant length. Thus, the delays of the received signals from this observed point are equalized at the output of all the receivers that are coupled to their respective antenna. This information will be stored in a memory. The measurements of all the antennas are combined and may be repeated and averaged to remove noise. Then the antenna array is electronically adjusted to be moved to next adjacent point in the brain and the above measurements for all the antennas of the array are performed again.

In another embodiment, the signals are amplified according to their distance from the point being observed. That is, the signal being observed from a point in the brain that is closest to one of the given antennas in the array should have the greatest reference magnitude. All other signals are amplified according to the extra distance (approx, the inverse square law) between the one with the greatest reference magnitude and any of the signals being captured by the other antennas. These other signals propagate further before reaching their respective antenna. The difference in length is used to calculate the amplification applied to these other signals. This information will be stored in a memory. In one embodiment, the amplification occurs accordingly to the inverse square law. The signals are then combined.

In another embodiment, a reference head is used to calibrate the antenna array. The reference head will contain transceivers within the various parts of the brain. These transceivers, being in known locations, will be used to calibrate the antenna array that uses one or more of the embodiments mentioned in this document. Thus, in the case of receiving signals from the brain, a given transceiver within the brain will transmit a signal and the antenna array along with its receiver comprised of its antenna, its adjustable-gain low-noise amplifier, and adjustable delay element will adjust the characteristics of the multiple signal paths from the observed point in the brain to all of the outputs of the transceivers within the antenna array. This information will be stored in a memory. In one embodiment, the outputs of all the transceivers in the antenna array are combined to strengthen the signal. The next transceiver within the brain is enabled and the tests are done in the same fashion.

In another embodiment, with a great many samples of reference heads where the transceivers are placed in many different random locations between the reference heads. The tests of transmitting to the brain or receiving from the brain can run over the multiple heads. The results stored in memory to adjust the characteristics of each of the links between the point within the brain and each of the antennas in the antenna array establishes a vast database that can be used to train a large language model (LLM). The trained LLM will provide the proper characteristics that need to be applied to each of the links that are established as the brain is scanned along a plurality of rows or a plurality of columns within the brain. This scanning includes either transmitting data to the brain or when data is received from the brain.

In another embodiment, these transceivers, being in known locations, will be used to calibrate the antenna array that uses one or more of the embodiments mentioned in this document. For example, in the case of transmitting signals to the brain, a given transceiver within the brain will receive a signal from each of the antennas in the antenna array, one at a time. The transmitter in the antenna array comprised of its antenna, its adjustable-gain power amplifier, and adjustable delay element will adjust the characteristics of each of these multiple signal paths or links from all of the outputs of the transceivers within the antenna array to the observed point in the brain. In one embodiment, the characteristics of the outputs of all the transceiver of the antenna array are matched to arrive at the observed point in the brain at the same time. In another embodiment, they arrive at the same time and with a pre-specified power level. Then, all transmitters in the antenna array can be enabled together combining the signal strengths that is then applied to the observed point in the brain. Observations of the finger movement or requests from the human subject as to what type of thoughts the subject may currently be thinking may be asked.

In another embodiment, the entire system of the antenna array and human subject are enclosed within a Faraday cage to remove extraneous outside RF signals that may degrade the measured brain signals or the application of the signals to the brain. In addition, the internals of the Faraday cage may contain an RF antechoir chamber to remove stray signals from other components of the body (i.e. the heart) or the remainder of the electrical system outside of the antenna array-brain system. In yet another embodiment, a shield may be placed around the neck between the head and the remainder of the body. The electronics of the baseband components of the transceiver of the antenna array may be enclosed within a shielded box to minimize unwanted noise from entering the antenna array-brain system. Any lower frequency processing equipment may be installed outside of the Faraday cage.

In one embodiment, the reference head may be an artificially constructed human head such that the skull and brain matter are synthesized to recreate an actual human's heads characteristics in response to the electromagnetic waves. In another embodiment, the reference head may be an actual preserved human head from a cadaver. In yet another embodiment, the human head may be a living human being where the transceivers are embedded in stents that are placed in the blood vessels within the brain in known locations. In calibration tests, either one of these three reference heads may be used to adjust the characteristics of the links between the antenna array and the various points in question within the brain. After obtaining a wealth of data, from numerous teats, artificial intelligence, such as LLMs, may be used to determine the characteristics on the fly and store this information into memory when scanning a given region of the brain. Once the LLM has calculated the proper characteristics for a given region, the data can be extracted from the memory to make a re-scan. This scan can be one where data is received from the brain or applied to the brain.

In another embodiment, the antennas of the antenna array are arranged in both a horizontal and vertical polarized orientation which allows the propagation of two independent signals simultaneously. The signals applied to these two sets of antennas may be different type of signals or they can be the same. In terms of different, the waveforms applied to the two sets of antenna may not be related at all. They are independent of each other. In terms of the same, the waveforms can be identical or they can be identical but time shifted and/or amplitude varied from one another.

Axons are the transmission lines coupling neurons together and can range in length from 1 mm to a meter in length. In another embodiment, these axons are modeled as lossy receiving antennas. The axons being conductors can pickup electromagnetic radiation of a carrier wave that is impinging along the axon's length. The wavelength of the electromagnetic radiation of the carrier wave optimally matches the length of the axon. In one embodiment, optimally can mean that the wavelength of the carrier wave can substantially be equal the length of the axon. In another embodiment, optimally can mean that the wavelength of the carrier wave can substantially be equal to a half or quarter of the length of the axon. In yet another embodiment, optimally can mean that the wavelength of the carrier wave can substantially be equal to twice or four times the length of the axon. The loss within the axon is due to the capacitance between the axon and its local environment or sheathing. The axon has a synapse at one of its ends. Together the axon and synapse act as a demodulator to extract the information signal that may have been modulated unto the carrier wave. In one embodiment, the information signal amplitude modulates the carrier wave. The information signal has a frequency that is less than the frequency of the carrier wave. In one embodiment, the information signal is a low frequency signal between 1 Hz to 100 or 200 Hz. This synapse acts as a low pass filter will capture the low frequency components of the incoming radiated signal. The capacitance in the axon channels the higher frequencies components of the carrier wave to ground. If this filter embodiment is excited by a high frequency carrier wave signal (GHz's) that is amplitude modulated with a low frequency signal (10 Hz's), the high frequency components are shorted to ground while the low frequency is captured by the axon. This could be one mode of signal delivery of the low frequency signal being delivered to the axons to control their behavior. The issue of heating due to the high frequency portion (channeling through the capacitance and parasitic resistance) of the low pass filter may be an important aspect when determining the maximum power levels of the amplitude modulated signal that would be delivered to the axons.

In another embodiment, the amplitude modulate system can easily be used to search for the behavior of the axons due to variations or changes in the low frequency signal that is amplitude modulating the high frequency carrier waveform.

In another embodiment, the antenna array system is adjusted to measure frequencies outside the ranges of frequencies of either A) or B) as mentioned above to see if the brain emits or is sensitive other ranges of frequencies.

In another embodiment, an axon-synapse activation apparatus comprising: an antenna, wherein said antenna has a first length; a transceiver coupled to said antenna; a modulator, wherein an information signal modulates a carrier wave generating a modulated signal, wherein a wavelength of said carrier wave is optimized to match said first length of said antenna; an axon having a second length, wherein a first end of said axon is coupled to a neuron via a synapse; and an output of said modulator couples said modulated signal to said antenna, wherein said axon wirelessly captures from said antenna said modulated signal along its said second length, wherein said axon and said synapse demodulate said modulated signal to extract said first information, and wherein said information signal is applied as an input stimulus to said neuron to activate said neuron. The apparatus wherein said neuron is in the brain of a human, wherein said activated neuron produces a response in said human. The apparatus wherein said information signal is an action potential. The apparatus wherein said wavelength of said carrier wave optimally matches said second length of said axon. The apparatus wherein said antenna is orientated substantially parallel to said axon. The apparatus wherein said axon is in a near-field electromagnetic radiation relationship to said antenna. The apparatus wherein said information signal amplitude modulates said carrier wave. The apparatus further comprising: an amplifier to amplify said modulated signal before being applied to said antenna.

In another embodiment, an axon-synapse activation apparatus comprising: an axon having a length; wherein a first end of said axon is coupled to a neuron via a synapse, wherein said axon wirelessly captures along its said length an amplitude modulated electromagnetic signal modulated by an information signal, wherein said axon and said synapse demodulate said amplitude modulated electromagnetic signal to extract said information signal, and wherein said information is applied as an input stimulus to said neuron via said synapse to activate said neuron. The apparatus wherein said neuron is in the brain of an animal, wherein said activated neuron produces a response in said animal. The apparatus wherein said information signal is an action potential. The apparatus further comprising: an antenna, wherein said antenna has a first length; a transceiver coupled to said antenna; and a modulator, wherein said information signal modulates a carrier wave generating a modulated signal, wherein a wavelength of said carrier wave is optimized to match said first length of said antenna. The apparatus wherein said wavelength of said carrier wave optimally matches said length of said axon. The apparatus wherein said antenna is orientated substantially parallel to said axon. The apparatus wherein said axon is in a near-field electromagnetic radiation relationship to said antenna. The apparatus of wherein said information signal amplitude modulates said carrier wave. The apparatus of further comprising: an amplifier to amplify said modulated signal before being applied to said antenna.

In another embodiment, an axon-synapse activation apparatus comprising: a plurality of axons each having substantially a same first length; wherein a first end of said axons are each coupled to a neuron via a synapse, wherein said axons wirelessly capture along its said first length an amplitude modulated electromagnetic signal modulated by an information signal, wherein said axons and said synapses each demodulate said amplitude modulated electromagnetic signal to extract said information signal, and wherein said information is applied as an input stimulus to said coupled neuron via said synapse to activate its corresponding said neuron. The apparatus wherein each said neuron is in the brain of an animal, wherein each said activated neuron together produces a response in said animal. The apparatus wherein said animal is a human. The apparatus wherein said information signal is an action potential. The apparatus further comprising: a plurality of antennas, wherein said antennas have a second length, wherein said antennas are each parallel aligned to one another, and wherein said antennas are arranged as an array within an area; a transceiver coupled to said plurality of antennas; a controllable phased delay element between said transceiver and said antennas; an electronic steering control that adjusts said delay element in said controllable phased delay path such that a wave front of said wireless amplitude modulated electromagnetic signals emitted from all antennas of said array substantially arrive simultaneously in a region containing said plurality of axons; and a modulator, wherein said information signal modulates a carrier wave generating said amplitude modulated electromagnetic signal, wherein a wavelength of said amplitude modulated carrier wave is optimized to match said second length of said antenna. The apparatus wherein said wavelength of said carrier wave optimally matches said length of said axons. The apparatus wherein said antennas are orientated substantially parallel to said axons. The apparatus wherein said axons are in a near-field electromagnetic radiation relationship to said antennas. The apparatus wherein said axons are in a far-field electromagnetic radiation relationship to said antennas. The apparatus wherein said information signal amplitude modulates said carrier wave. The apparatus further comprising: an amplifier to amplify said modulated signal before being applied to said antenna.

In another embodiment, an axon-synapse activation and detection apparatus comprising: an axon comprising a first axon having a first length in series with a second axon having a second length, wherein said second axon is orthogonal to said first axon; wherein an end of said second axon is coupled to a neuron via a synapse, wherein said first axon wirelessly captures along its said first length a first amplitude modulated carrier wave modulated by an information signal; a current is produced when said first amplitude modulated carrier wave propagates in said second axon, wherein said current generates a second amplitude modulated carrier wave that is emitted wirelessly from said second axon, wherein said synapse demodulates said second amplitude modulated carrier wave to extract said information signal, and wherein said information is applied as an input stimulus to said neuron via said synapse to activate said neuron. The apparatus wherein said neuron is in the brain of an animal, wherein said activated neuron produces a response in said animal. The apparatus wherein said information signal is an action potential. The apparatus further comprising: a first antenna, wherein said antenna has a third length; a transceiver coupled to said first antenna; and a modulator, wherein said information signal modulates a carrier wave generating a modulated signal, wherein a wavelength of said carrier wave is optimized to match said third length of said first antenna. The apparatus wherein said wavelength of said carrier wave optimally matches said first length of said first axon. The apparatus wherein said first antenna is orientated substantially parallel to said first axon. The apparatus wherein said first axon is in a far-field electromagnetic radiation relationship to said first antenna. The apparatus wherein said information signal amplitude modulates said carrier wave. The apparatus further comprising: an amplifier to amplify said modulated signal before being applied to said antenna. The apparatus further comprising: a second antenna formed from said second axon, wherein said current generates a second amplitude modulated carrier wave that is emitted wirelessly from said second antenna, wherein said antenna has a second length. The apparatus further comprising: a third antenna, wherein said third antenna has a fourth length, and said third antenna wirelessly receives said second amplitude modulated carrier wave from second antenna; a transceiver coupled to said third antenna; and a modulator, wherein said modulator mixes a second carrier wave with said second amplitude modulated carrier wave to extract said information signal, wherein a wavelength of said second carrier wave is optimized to match said fourth length of said third antenna, The apparatus wherein said wavelength of said second carrier wave optimally matches said second length of said second axon. The apparatus wherein said second antenna is orientated substantially perpendicular to said first antenna. The apparatus wherein said second antenna is orientated substantially parallel to said third antenna. The apparatus wherein said second axon is in a near-field electromagnetic radiation relationship to said third antenna. The apparatus, further comprising: an amplifier to amplify said received signal before being applied to said modulator.

In another embodiment, an axon-synapse activation and detection apparatus comprising: a plurality of axons each comprising a first axon having a first length in series with a second axon having a second length, wherein said second axon is orthogonal to said first axon; wherein an end of said second axon is coupled to a neuron via a synapse, wherein said first axon wirelessly captures along its said first length a first amplitude modulated carrier wave modulated by an information signal; a current is produced when said first amplitude modulated carrier wave propagates in each of said second axons, wherein said combined current generates a second amplitude modulated carrier wave that is emitted wirelessly from said second axons, wherein each said synapse demodulates said second amplitude modulated carrier wave to extract said information signal, and wherein said information is applied as an input stimulus to each said neuron via said synapse to activate said neuron. The apparatus wherein said neuron is in the brain of an animal, wherein said activated neuron produces a response in said animal. The apparatus wherein said information signal is an action potential. The apparatus further comprising: a plurality of first antennas, wherein said antennas have a third length, wherein said antennas are each parallel aligned to one another, and wherein said antennas are arranged as an array within an area; a transceiver coupled to said plurality of antennas; a controllable phased delay element between said transceiver and said antennas; an electronic steering control that adjusts said delay element in said controllable phased delay path such that a wave front of said wireless amplitude modulated electromagnetic signals emitted from all first antennas of said array substantially arrive simultaneously in a region containing said plurality of first axons; and a modulator, wherein said information signal modulates a carrier wave generating said amplitude modulated electromagnetic signal, wherein a wavelength of said amplitude modulated carrier wave is optimized to match said third length of said antenna. The apparatus wherein said wavelength of said carrier wave optimally matches said first length of all said first axons. The apparatus wherein said first antenna is orientated substantially parallel to said first axons. The apparatus wherein said first axons are in a far-field electromagnetic radiation relationship to said first antennas. The apparatus wherein said information signal amplitude modulates said carrier wave. The apparatus further comprising: an amplifier to amplify said modulated signal before being applied to said antenna. The apparatus further comprising: a plurality of second antenna formed from each of said second axons, wherein said current generates a second amplitude modulated carrier wave that is emitted wirelessly from each of said second antennas, wherein said antennas has a second length. The apparatus further comprising: a plurality of third antenna, wherein said third antenna has a fourth length, and said third antenna wirelessly receives said second amplitude modulated carrier wave from plurality of second antenna; a transceiver coupled to said plurality of third antennas; and a modulator, wherein said modulator mixes a second carrier wave with said second amplitude modulated carrier wave to extract said information signal, wherein a wavelength of said second carrier wave is optimized to match said fourth length of said plurality of third antenna. The apparatus wherein said wavelength of said second carrier wave optimally matches said second length of said plurality of second axons. The apparatus wherein said plurality of second antennas are orientated substantially perpendicular to said plurality of first antennas. The apparatus wherein said plurality of second antennas is orientated substantially parallel to said plurality of third antennas. The apparatus wherein said plurality of second axons are in a near-field electromagnetic radiation relationship to said plurality of third antennas. The apparatus further comprising: an amplifier to amplify said received signal before being applied to said modulator.

In another embodiment, an axon-synapse detection apparatus comprising: a plurality of axons each comprising a same first length axon in series with a same second length axon, wherein said first length axon is orthogonal to said second length axon; a neuron coupled via a synapse to an end of said second length axon, wherein said first length axons wirelessly capture along its said first length an amplitude modulated electromagnetic signal modulated by an information signal, wherein said first length axons and said synapses each demodulate said amplitude modulated electromagnetic signal to extract said information signal, and wherein said information is applied as an input stimulus to said coupled neuron via said synapse to activate its corresponding said neuron. The apparatus of wherein each said neuron is in the brain of an animal, wherein each said activated neuron together produces a response in said animal. The apparatus wherein said animal is a human. The apparatus wherein said information signal is an action potential. The apparatus further comprising: a plurality of antenna, wherein said antennas have a second length, wherein said antennas are each parallel aligned to one another, and wherein said antennas are arranged as an array within an area; a transceiver coupled to said antennas; a controllable phased delay element between said transceiver and said antennas; an electronic steering control that adjusts said delay element in said controllable phased delay path such that a wave front of said wireless amplitude modulated electromagnetic signals emitted from all antennas of said array substantially arrive simultaneously in a region containing said plurality of axons; and a modulator, wherein said information signal modulates a carrier wave generating said amplitude modulated electromagnetic signal, wherein a wavelength of said amplitude modulated carrier wave is optimized to match said second length of said antenna. The apparatus of wherein said wavelength of said carrier wave optimally matches said length of said axons. The apparatus of wherein said antennas are orientated substantially parallel to said axons. The apparatus of wherein said axons are in a near-field electromagnetic radiation relationship to said antennas. The apparatus wherein said axons are in a far-field electromagnetic radiation relationship to said antennas. The apparatus wherein said information signal amplitude modulates said carrier wave. The apparatus further comprising: an amplifier to amplify said modulated signal before being applied to said antenna.

### BRIEF DESCRIPTION OF THE DRAWINGS

Please note that the drawings shown in this specification may not necessarily be drawn to scale and the relative dimensions of various elements in the diagrams are depicted schematically. The inventions presented here may be embodied in many different forms and should not be construed as limited to the embodiments set forth herein. Rather, these embodiments are provided so that this disclosure will be thorough and complete, and will fully convey the scope of the invention to those skilled in the art. In other instances, well-known structures and functions have not been shown or described in detail to avoid unnecessarily obscuring the description of the embodiment of the invention. Like numbers refer to like elements in the diagrams.

FIG. 1 shows a side perspective view of the left and right hemispheres of the brain in the present disclosure.

FIG. 2 depicts a view of a neuron connecting to other neurons via axons and dendrites in the present disclosure.

FIG. 3A depicts a cross-sectional view of the grey matter in the cerebral cortex of a human in the present disclosure.

FIG. 3B shows a cross-sectional view of a lateral fissure in the human brain in the present disclosure.

FIG. 3C illustrates a top-view of FIG. 3B in the present disclosure.

FIG. 4 depicts an axon surrounded with a myelin sheaths in the present disclosure.

FIG. 5 presents another perspective of the axon surrounded by myelin sheaths in the present disclosure.

FIG. 6 show the stages of an action potential and the permeability of the membrane of the neuron changes in the present disclosure.

FIG. 7 depicts the Hodgkin-Huxley model or conductance-based model in the present disclosure.

FIG. 8 shows the equivalent circuit of the axon utilizing the cable theory in the present disclosure.

FIG. 9 illustrates three types of glial cells are astrocytes, oligodendrocytes, and ependymal cells, known collectively as macroglia in the present disclosure.

FIG. 10A depicts a current clamp recording of a neuron firing in the present disclosure.

FIG. 10B depicts the nerve (axon) network in the human body in the present disclosure.

FIG. 11 illustrates the projectile moving past the end of the periodic arrangement of magnets and stopping thereby converting the entire projectile's kinetic energy to potential energy in the present disclosure.

FIG. 11 shows the mapping of the various regions of the brain in the present disclosure.

FIG. 12 depicts one example of electrode placement on a human subject in the present disclosure.

FIG. 13A illustrates one embodiment of a side-view of two different length axons in accordance with the present disclosure.

FIG. 13B shows one embodiment of the tubular structure of an axon in accordance with the present disclosure.

FIG. 13C depicts one embodiment of the electrical model of the axon in FIG. 13A in accordance with the present disclosure.

FIG. 14A shows one embodiment of a side-view of a myelinated axon in accordance with the present disclosure.

FIG. 14B depicts one embodiment of the tubular structure of the axon in accordance with the present disclosure.

FIG. 14C shows one embodiment of the electrical model of the axon in FIG. 14A in accordance with the present disclosure.

FIG. 15A illustrates one embodiment of a transceiver coupled to a dipole orientated at right angles to an axon within a plane in accordance with the present disclosure.

FIG. 15B depicts one embodiment of a transceiver coupled to a dipole orientated in parallel to an axon within a plane in accordance with the present disclosure.

FIG. 15C illustrates one embodiment of a transceiver coupled to a dipole orientated at right angles within a plane perpendicular to a second plane comprising an axon in accordance with the present disclosure.

FIG. 15D presents one embodiment of a front-end view of FIG. 15C in accordance in accordance with the present disclosure.

FIG. 16A shows one embodiment of a quarter wave dipole antenna coupling to an axon in a leg of a human in accordance with the present disclosure.

FIG. 16B depicts one embodiment of a smaller quarter wave dipole antenna coupling to an axon in a brain of a human in accordance with the present disclosure.

FIG. 17A shows one embodiment of a long wavelength electromagnetic wave approaching a long axon in accordance with the present disclosure.

FIG. 17B shows one embodiment of a short wavelength electromagnetic wave approaching a short axon in accordance with the present disclosure.

FIG. 17C depicts one embodiment of a short and long frequency signal waveforms in accordance with the present disclosure.

FIG. 17D presents a table of axon lengths vs. antenna and frequency parameters in accordance in accordance with the present disclosure.

FIG. 18A shows one embodiment of a plurality of antennas interacting with an axon in accordance with the present disclosure.

FIG. 18B displays a portion 1-3 of the lateral fissure 1-1 of the brain illustrated in FIG. 1 showing the axons 3-7, 3-9 and 3-11 as indicated in FIG. 3B and FIG. 3C in accordance with the present disclosure.

FIG. 18C depicts one embodiment of an antenna array coupling to the axons 3-7, 3-9 and 3-11 of FIG. 3B and FIG. 3C in the brain of FIG. 10f a human in accordance with the present disclosure.

FIG. 19A through FIG. 19C show two different embodiments of an apparatus used to interact with the axons of a human subject in accordance with the present disclosure.

FIG. 20 shows one embodiment of a Faraday cage to isolate the antenna array from the world and the remainder of the human body in accordance with the present disclosure.

FIG. 21 depicts one embodiment of an apparatus used to apply modulated brain signals to the axons or dendrites within a given volume of a brain in accordance with the present disclosure.

FIG. 22 depicts another embodiment of an apparatus used to apply modulated brain signals to the axons or dendrites within a given volume of a brain in accordance with the present disclosure.

FIG. 23 shows another embodiment of an apparatus used to apply modulated brain signals to the axons or dendrites within a given volume of a brain aided by large language models in accordance with the present disclosure.

FIG. 24 shows another embodiment of an apparatus used to receive modulated brain signals from the axons or dendrites within a given volume of a brain aided by large language models in accordance with the present disclosure.

FIG. 25 depicts one embodiment of a waveform that is amplitude modulated by a high frequency signals where either m<1 or m>1 in accordance with the present disclosure.

FIG. 26 shows another embodiment of an amplitude modulated waveform and the frequency spectrum where either the waveform is a sinusoidal, a broadband signal or a band-limited signal in accordance with the present disclosure.

FIG. 27A depicts one embodiment of an electromagnetic amplitude modulated waveform received by the antenna equivalent circuit representation of an axon and the automatic demodulation of the signal after the signal is captured in accordance with the present disclosure.

FIG. 27B depicts one embodiment of the waveforms of FIG. 28A when the signal is electromagnetic, when the signal is captured, and when the signal is demodulated in accordance with the present disclosure.

### DETAILED DESCRIPTION OF THE INVENTION

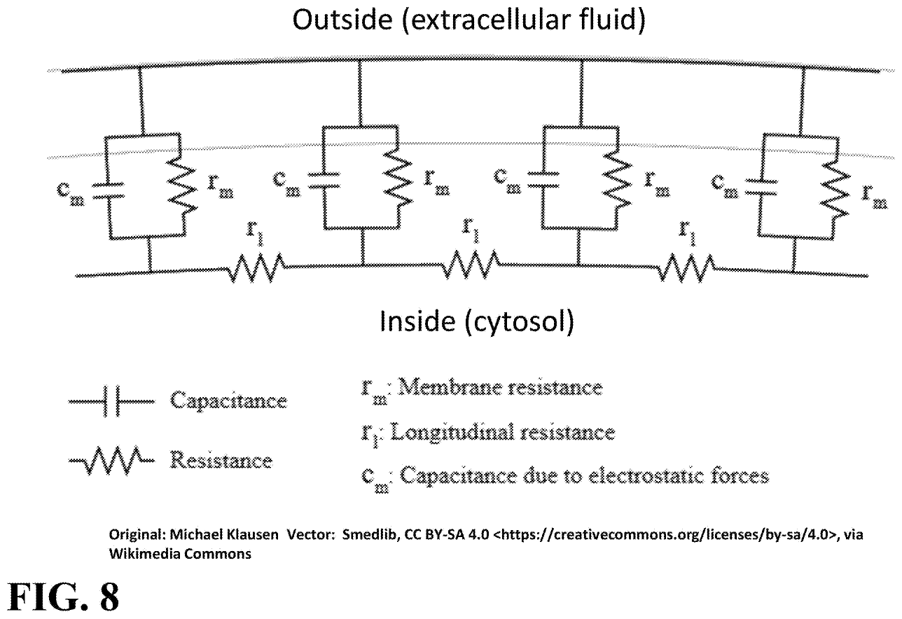

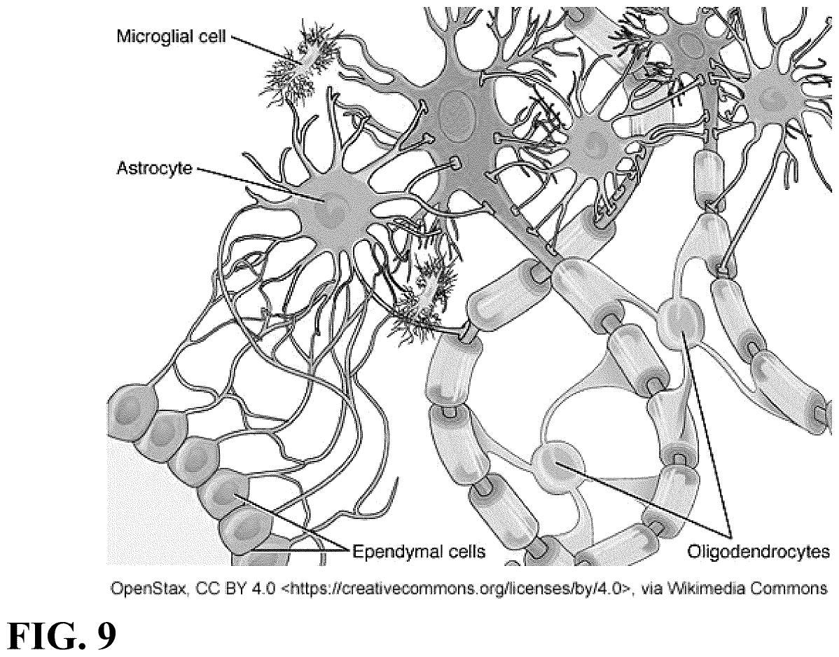

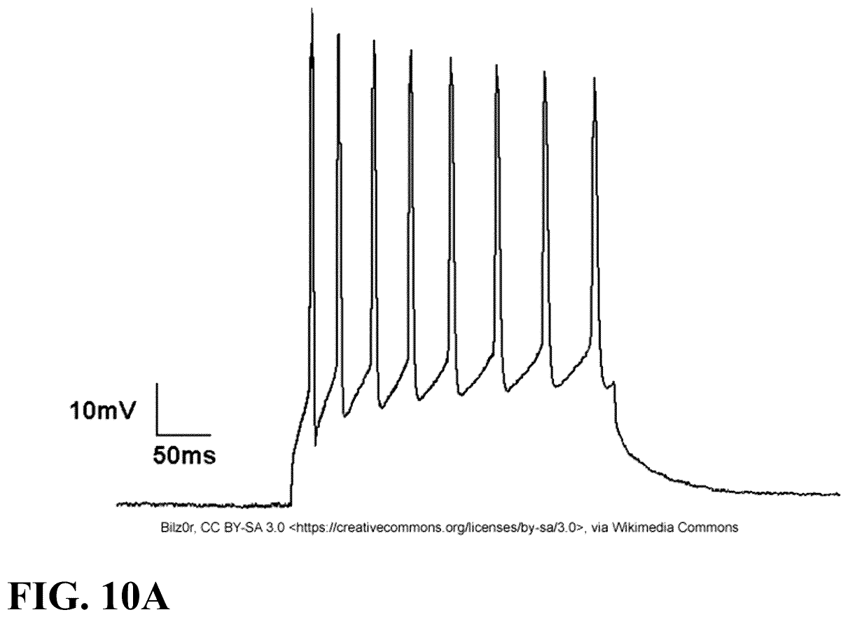

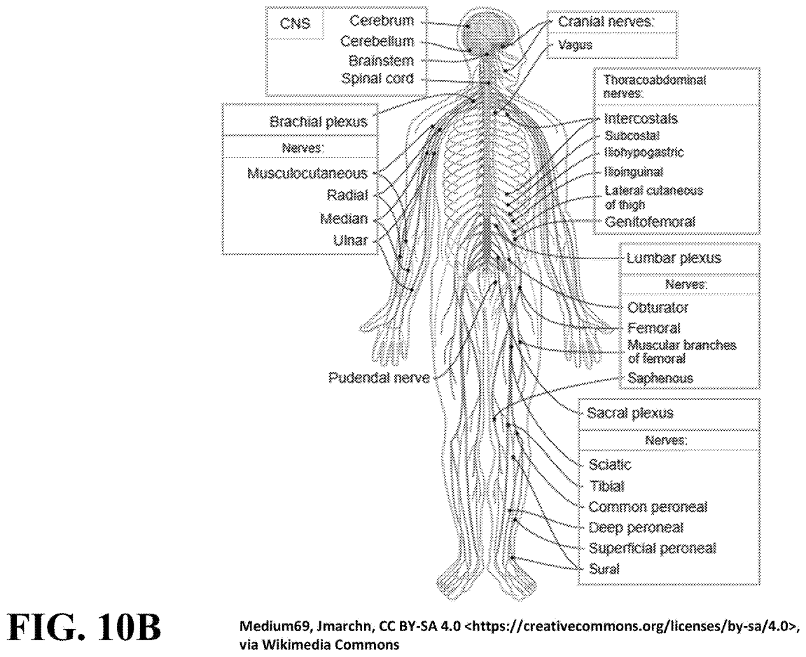

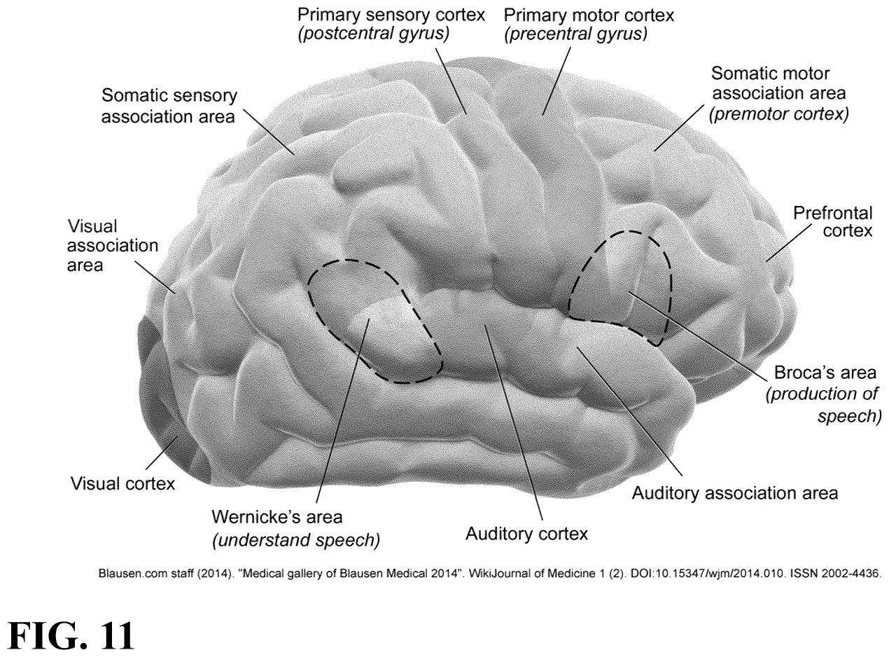

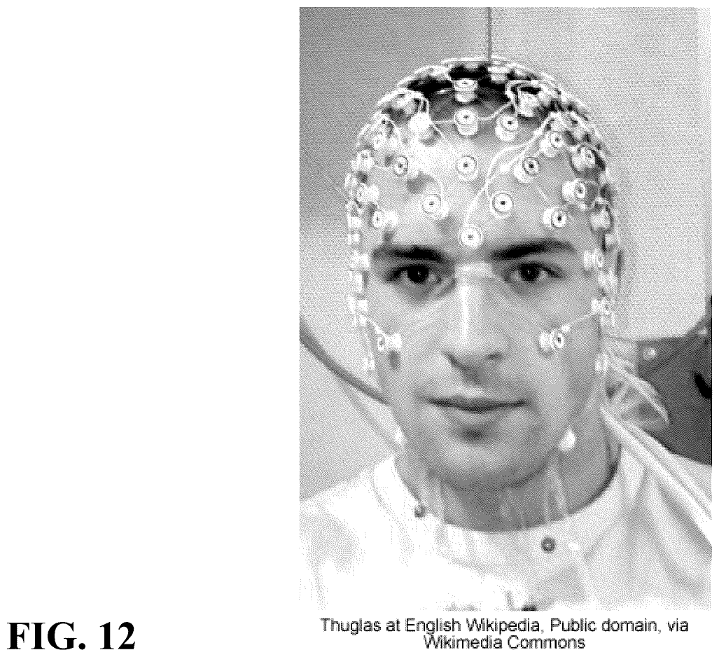

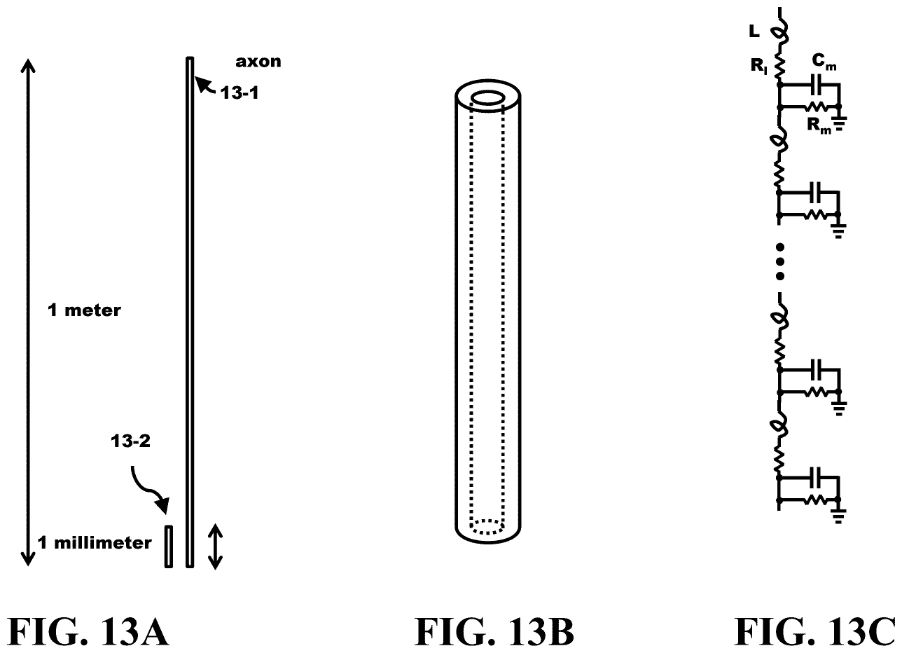

FIG. 13A shows the possible variation of lengths of axons or in the human body. At one extreme, the length of an axon 13-1 can be 1 meter; at the other end, the axon 13-2 can have a length of 1 millimeter. In one embodiment, the cylindrical tube in FIG. 13B is a model representing the structure of the axon given in FIG. 13A which also carries the current of the action potential. Dendrites also carry currents. The electrical equivalent model of the axon was provided earlier in FIG. 8 and was given when calculating the cable equation. This model includes the Rₗ, the Cₘ, and the Rₘ components, as given earlier. Note the absence of inductors in this earlier model. However, current does flow in the axon. This current produces a magnetic field and therefore an inductor, L, was added to the current model to account for this effect in FIG. 13C.

The electrical model in FIG. 13C will also be used in the present application to represent a leaky antenna. Note the basic primitive model comprising the Rₗ, Cₘ, Rₘ, and L components form the basic building block. This block is repeated over and over again in this model. This axon is a conductor and will be used to intercept incoming electromagnetic waves depending on its length and the frequency of the incoming signal.

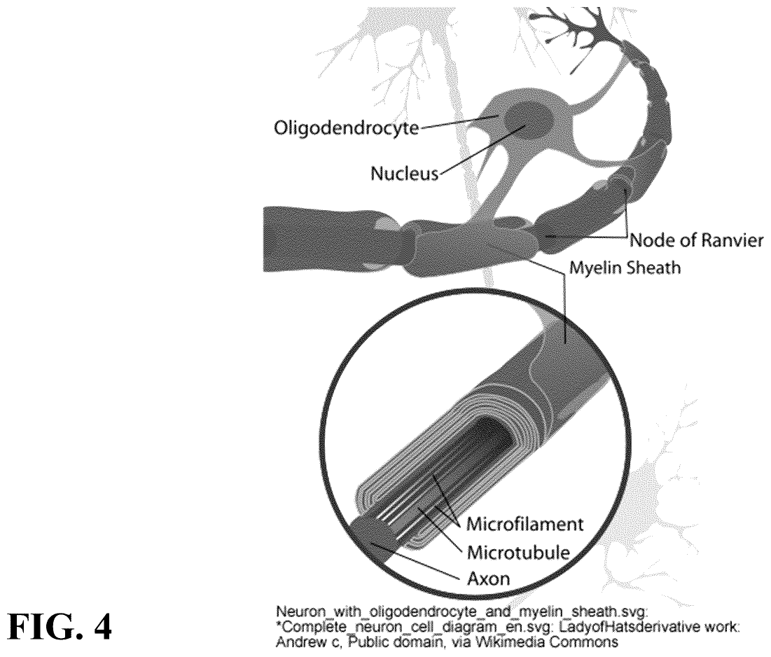

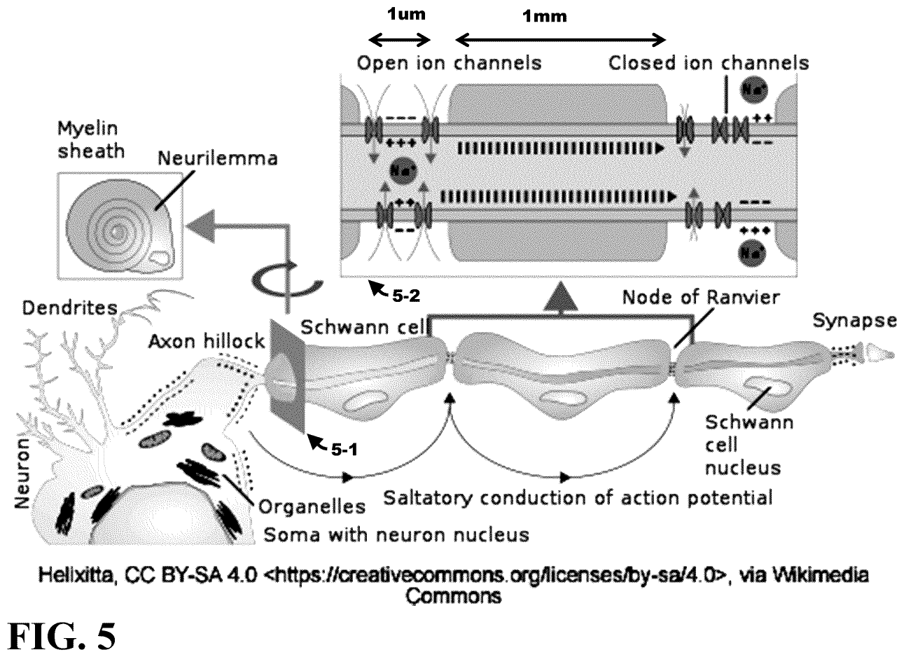

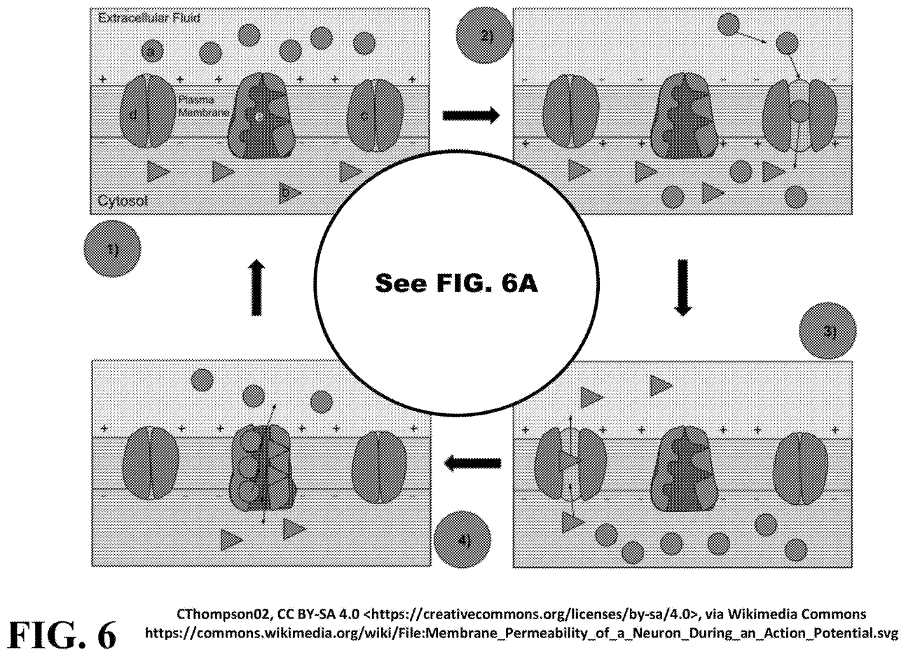

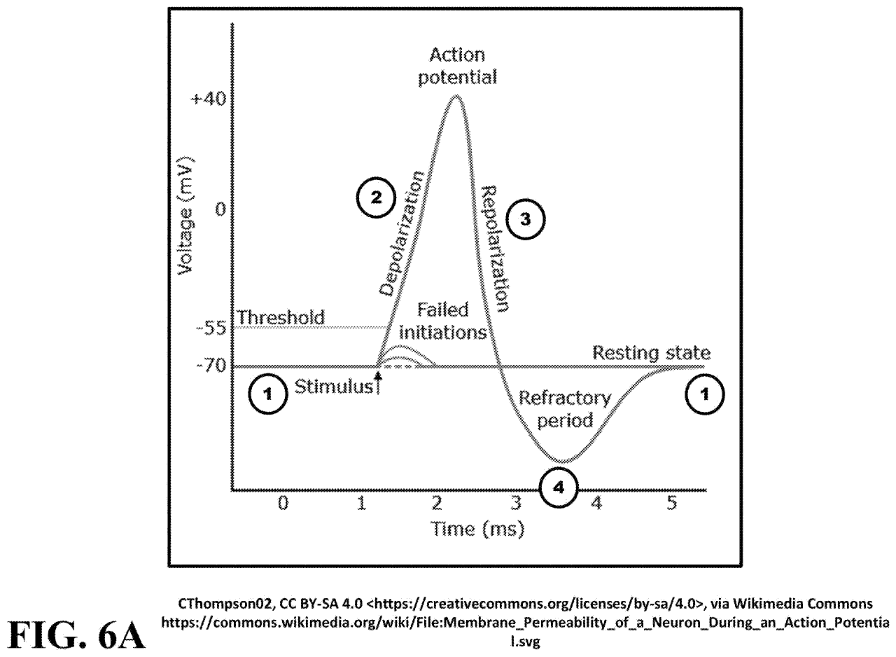

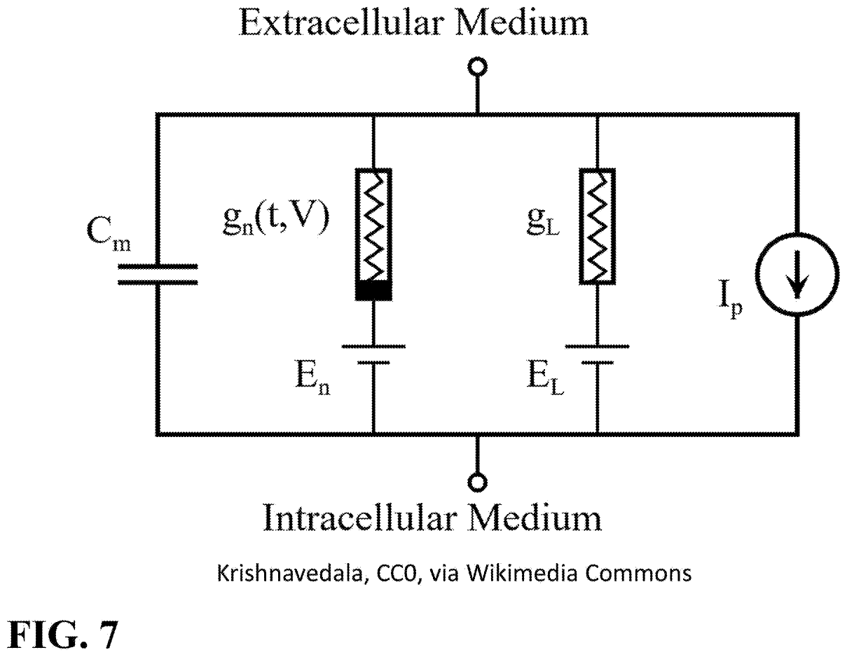

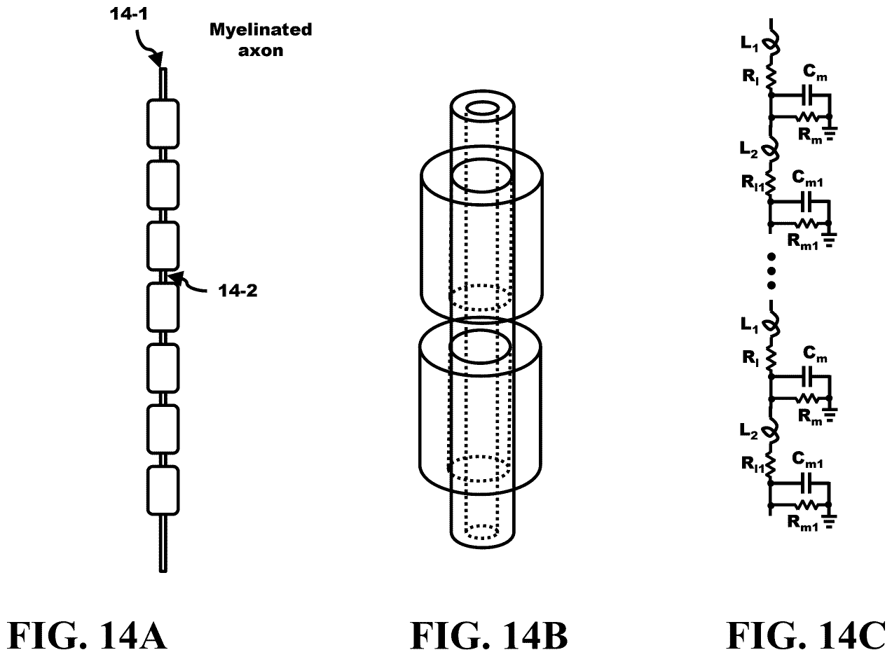

FIG. 14A illustrates a myelinated axon 14-1 as described earlier in FIG. 4 and FIG. 5. The node of Ranvier 14-2 is also shown. In one embodiment, the myelinated axons is represented by two different diameters of cylindrical tubes as depicted in FIG. 14B. This composite axon also carries the current of the action potential. The electrical equivalent model of the axon that was provided earlier in FIG. 8 has been modified. This model includes two different sets of the Rₗ, the Cₘ, and the Rₘ components, as given earlier. One is for the myelin coating; the other is for the node of Ranvier. This current produced in each of these two models produces a magnetic field and therefore equivalent inductors, L₁ and L₂, have been added to the each current model to account for this effect in FIG. 14C.

The electrical model in FIG. 14C will also be used in the present application to represent a leaky antenna. The two equivalent blocks are repeated over and over again in this model. This axon is a conductor and will be used to intercept incoming electromagnetic waves depending on its length and the frequency of the incoming signal.

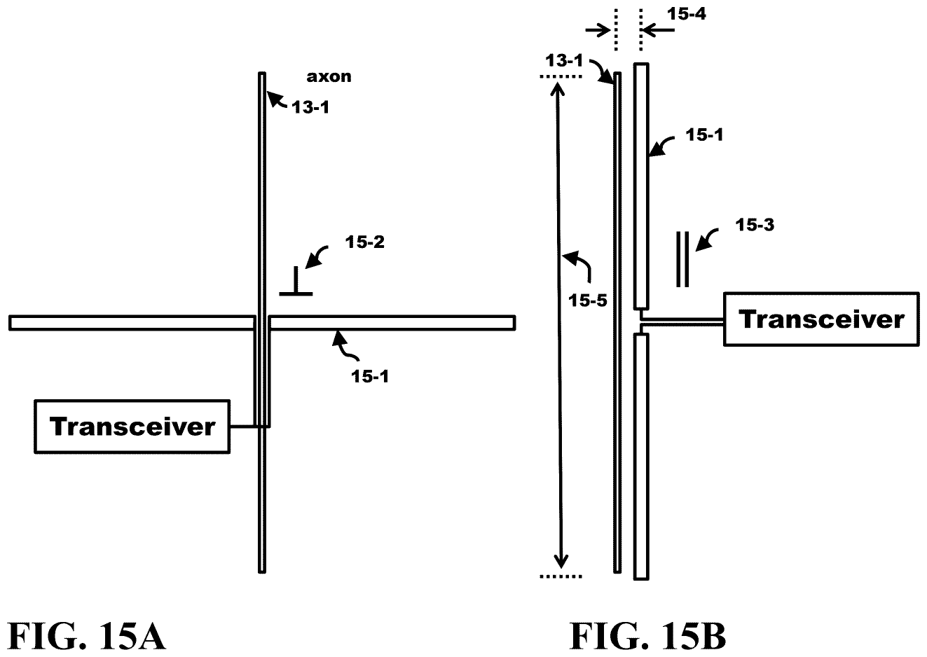

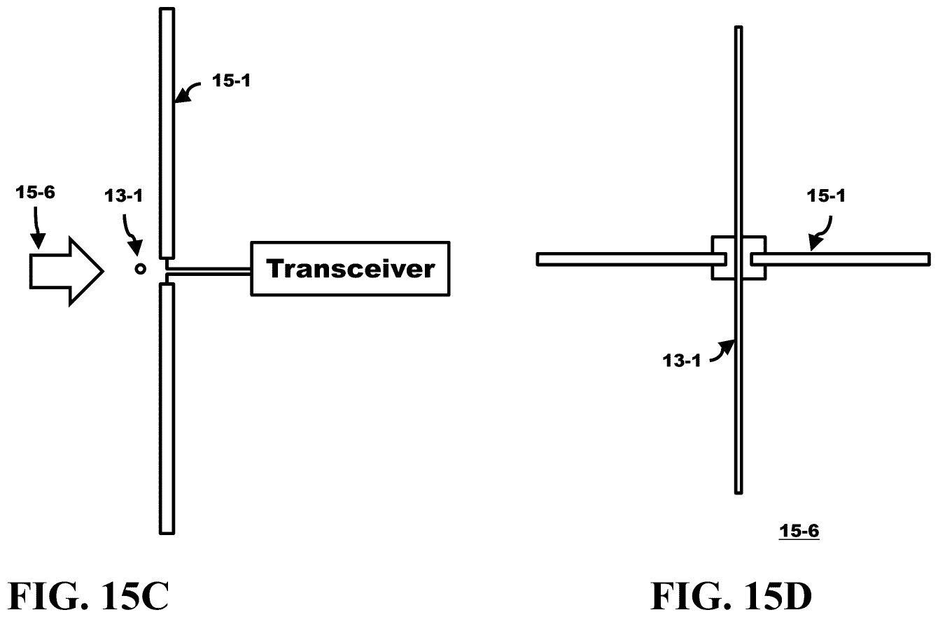

FIG. 15A illustrates a transceiver coupled to a ¼ wavelength dipole antenna. The dipole antenna is comprised of two ¼ wavelength antenna components where one of the components is shown as 15-1. The ¼ wavelength antenna 15-1 has a physical length that is ¼ the wavelength of the carrier wave wavelength of the electromagnetic radiation that is emitted from this structure.

The carrier wave wavelength of the signal emanating from the antenna has a carrier wave frequency that is proportional to 1/(period of time of the full wavelength of the carrier wave). As the period of time of the full wavelength is decreased, the frequency of the carrier wave is increased, and vice versa. The electrical system providing signals to the transceiver can be comprised of a modulated signal where the carrier wave frequency is modulated by a lower frequency signal. Thus, the lower frequency signal modulates the carrier wave signal allowing the antenna tuned to the characteristics of the carrier wave frequency to propagate the signal out of the antenna into the axon and carry the lower frequency signal to the axon. The ¼ wavelength dipole operates optimally when the carrier wave frequency is equal to a wavelength of the carrier wave frequency. However, the frequency of the carrier wave frequency can be varied around its optimal value yet still achieve propagation of the alter carrier wave frequency but at a less than optimal value.

In one embodiment, the axon 13-1 has a perpendicular 15-2 relation to the dipole antenna and is placed near the antenna. The electric field produced by the dipole antenna would impinge perpendicular to the axis of the axon minimizing the ability of the axon to perform as an antenna. Even though, the antenna is close, the electrical signal of the carrier wave has a decreased chance of being captured by the axon because the electrical field produced by the dipole is perpendicular 15-2 to the axon.

In FIG. 15B, the axon 13-1 is aligned with, or parallel 15-3 to, the dipole antenna. Note that in this embodiment, the antenna is close to the axon. The electric field produced by the antenna is a near-field because of the close proximity of the antenna to the axon. Near-field approximately occurs when the length of the antenna 15-5 is greater than the separation between the transmitting antenna 15-1 and axon 15-4 (where the axon 13-1 is behaving as an effective receiving antenna). In one embodiment, the axon may have a physical length that matches the ½ wavelength of carrier wave frequency of the dipole. In another embodiment, the axon may have an electrical length that is a full wavelength of the carrier wave frequency. In yet another embodiment, the axon may have an electrical length that is a ¼ wavelength or less than that of the carrier wave frequency emitted by the dipole antenna 15-1. Other types of antennas are possible as substitutions for the dipole antenna 15-1. Some of the embodiments include; a loop antenna, a bowtie antenna, monopole, array antenna, etc.

FIG. 15C illustrates a dipole antenna 15-1 in the vicinity of an axon 13-1 that is perpendicular to the page. A side view 15-6 of FIG. 15C is presented in FIG. 15D. As can be discerned from these two figures, the electric field of the transmission of the dipole antenna is perpendicular to that of the axon. For this embodiment, the transfer of the signal from the dipole to the axon is less than optimal.

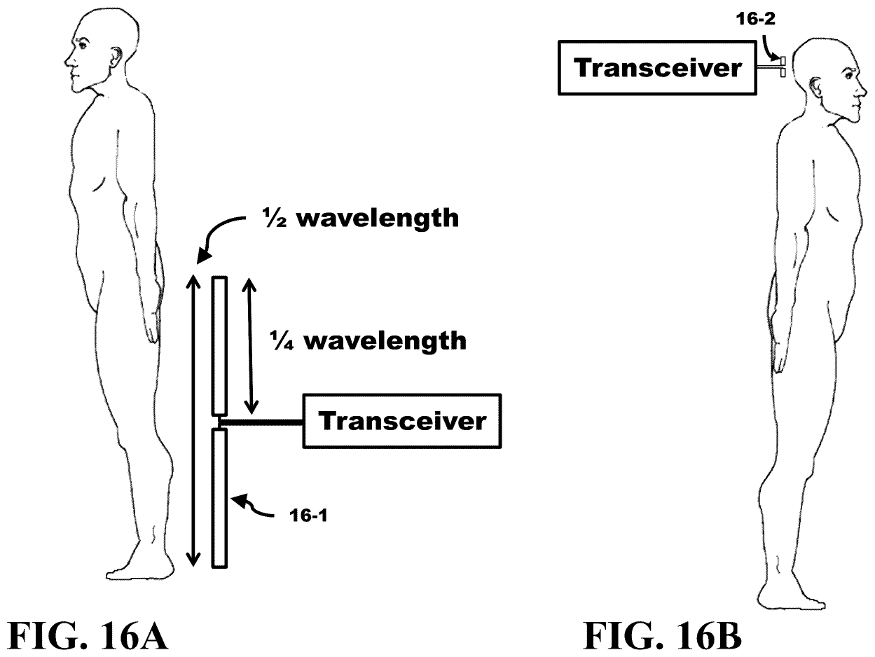

FIG. 16A illustrates one embodiment of transferring energy from the dipole antenna 16-1 to an axon that may be in the leg of the human. The frequency of the carrier wave wavelength would be proportional to the ½ wavelength of the dipole antenna. In FIG. 16B, the dipole 16-2 is much shorter where the emitted energy of the dipole 16-2 would be for a smaller length axon or dendrite in the brain. The carrier wave frequency of the energy emitting from dipole 16-2 would be much higher in frequency than that of the dipole 16-1.

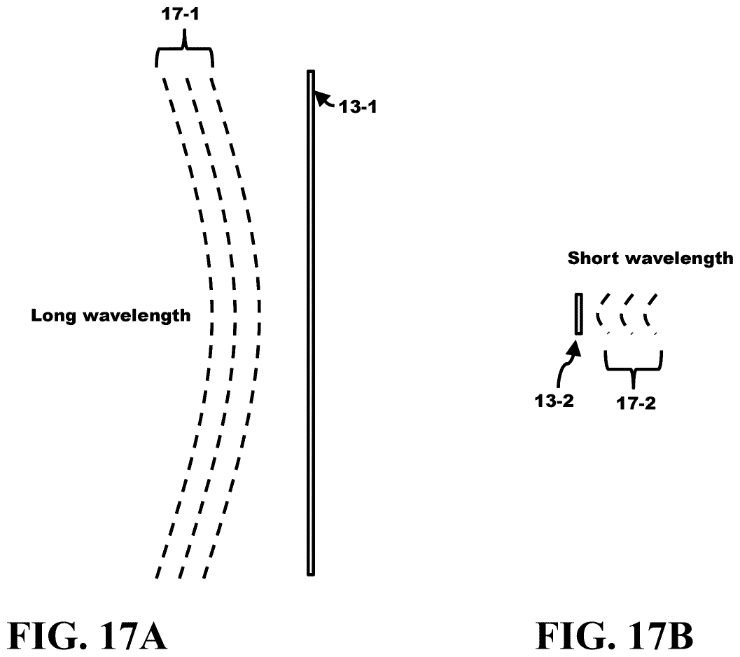

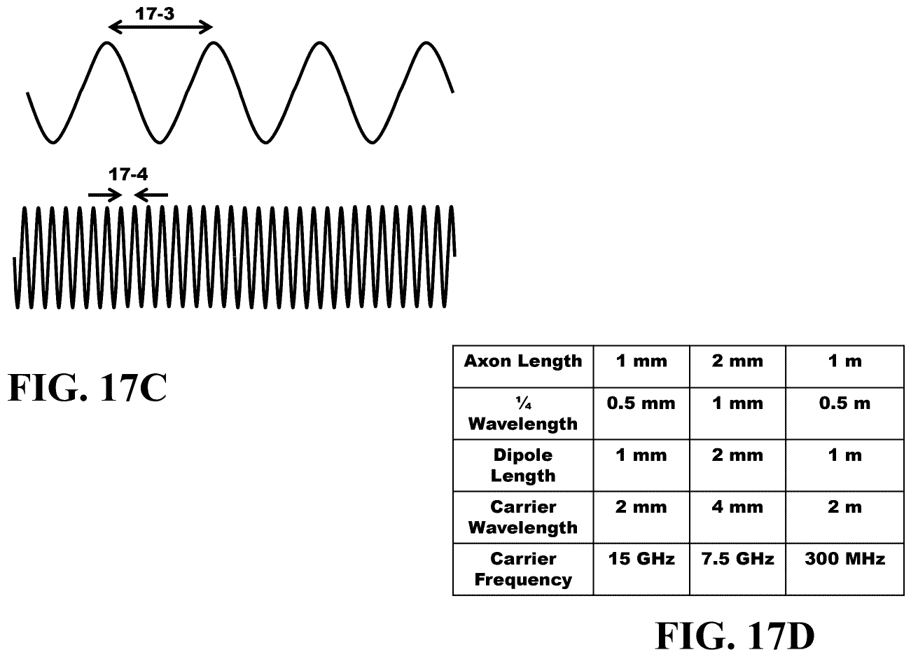

FIG. 17A illustrates in one embodiment the longer wavelength of the signal 17-1 impinging the axon 13-1, while in another embodiment the wavelength of a much shorter axon 13-2 would have its carrier wave wavelength shorter to better match the characteristics of the shorter axon.

FIG. 17C illustrates a long wavelength, lower frequency signal, 17-3 and a short wavelength, higher frequency signal, 17-4. In one embodiment, the lower frequency signal 17-3 can be used to modulate the higher frequency signal 17-4 carrier wave frequency. The lower frequency signal can be a sine wave, a waveform carrying information, such as, an action potential, or any type of random signal. In a first embodiment, the modulation can be amplitude modulation where the signal contains the power spectrum of both sidebands and the energy of the carrier wave frequency. In another embodiment, the modulation can be single side band amplitude modulation (SSB) where one side band is suppressed. In yet another embodiment, the modulation can be a modulation where both one sideband and the carrier wave frequency are suppressed. Reducing the power spectrum of the signal allows the signal to be delivered to the destination while minimizing unnecessary power to be expended in the receiving area which reduces local heating. This is important particularly when the signal is being applied to the brain. Minimizing the power spectrum of the signal minimizes the local heating.

FIG. 17D presents a table providing, in one embodiment, the length of the ¼ wavelength dipole, the length of the dipole, the carrier wave wavelength, and the carrier wave frequency when the axon length is 1 mm, 2 mm, and 1 meter. Assume the axon is 2 mm in length, in one embodiment, the ¼ wavelength can be 1 mm. In other embodiments, the ¼ wavelength can be more or less than this causing the energy transfer to the neuron to be less than optimal. However, resuming the analysis, the dipole length would be 2 mm, and the carrier wave wavelength would be 4 mm. This corresponds to a carrier wave frequency of 7.5 GHz. Thus, in one embodiment, the antenna would be placed close to the head of the subject. The 7.5 GHz signal would be amplitude modulated by a low frequency signal. One example of a low frequency signal would be the action potential. Thus, a signal can be synthesized to have a frequency between 1 and 100 Hz and be shaped to have the waveform similar to that of an action potential. The human subject can be monitored to how the brain stimulus affected the subject. The shapes of the waveforms can be modified to better understand the process. In addition, the carrier wave frequency can be modified over a range of frequencies to better understand the length of the axons that are being stimulated.

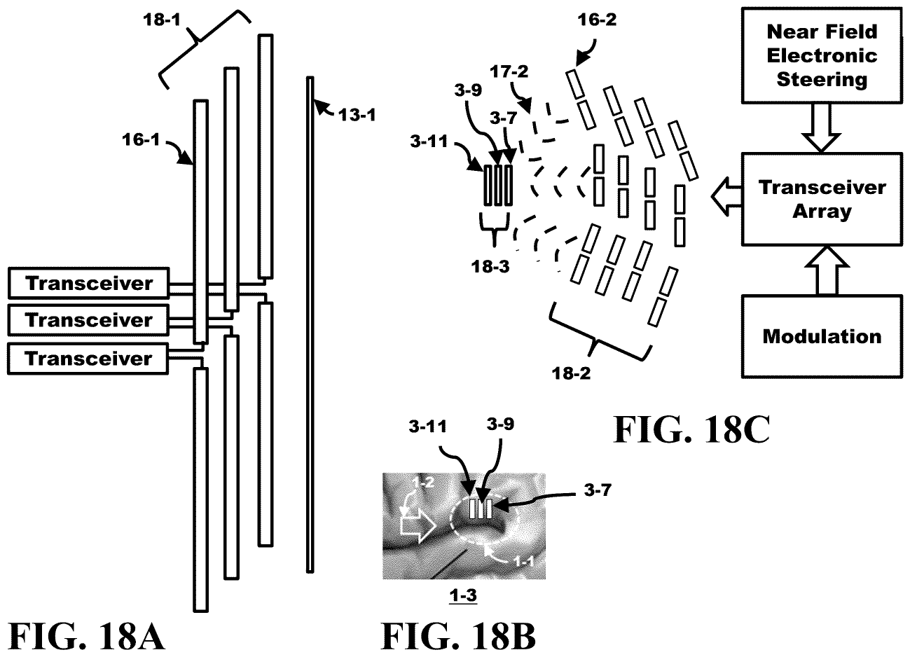

FIG. 18A illustrates the concept of antenna arrays 18-1 comprised of several dipole antenna 16-1 being used to stimulate the axon 13-1. In one embodiment, the transceivers are controlled to adjust the signal being applied to each of the dipoles such that the electromagnetic energy emitted from the dipoles arrive in the vicinity of the axon 13-1 and combine together to strengthen the signal being applied to this vicinity.

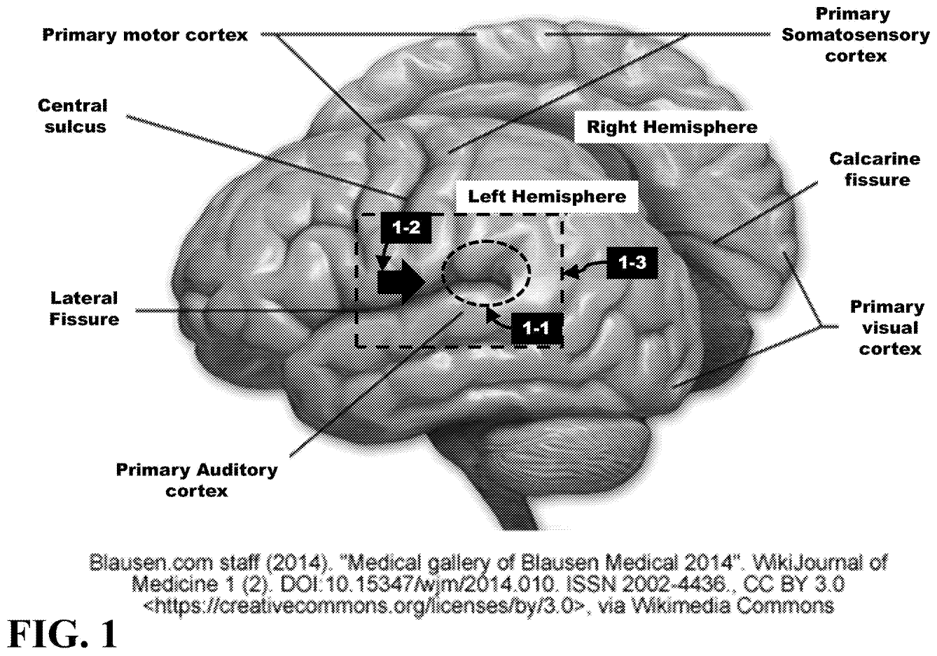

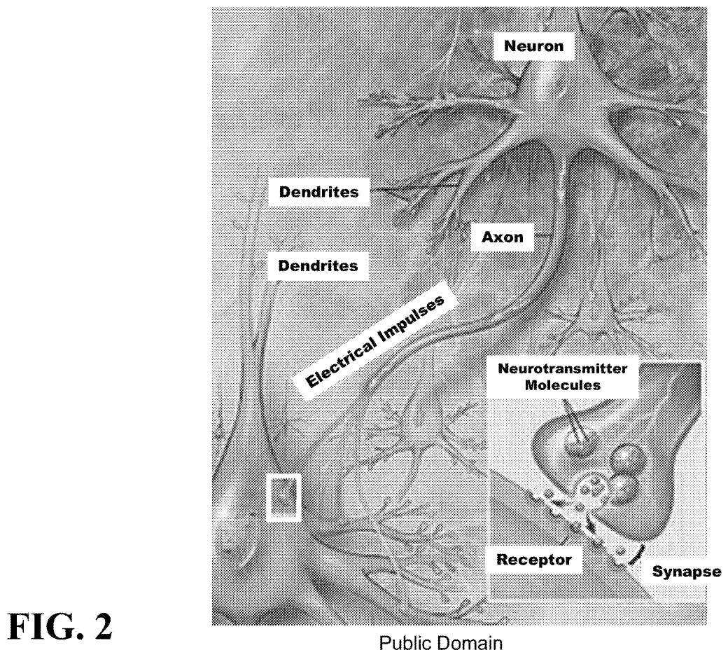

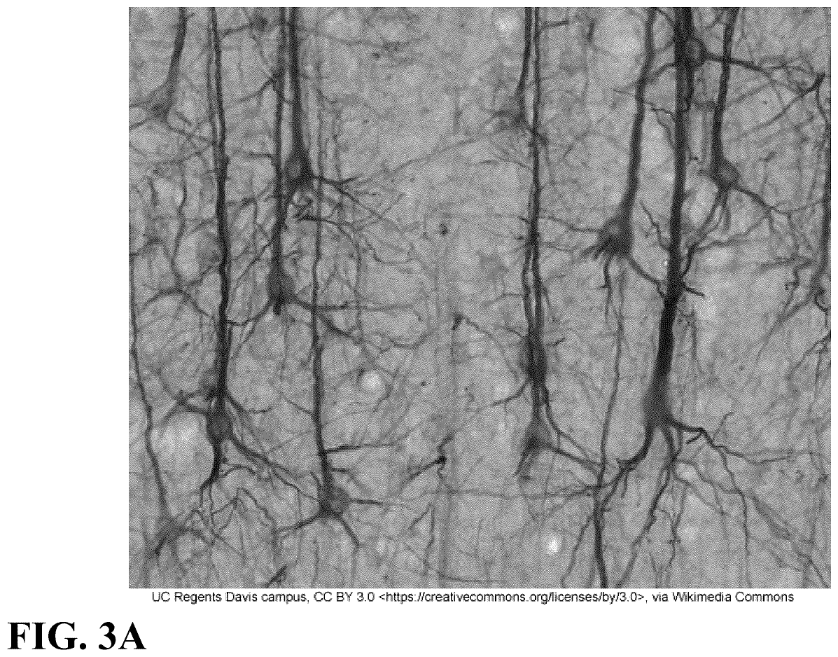

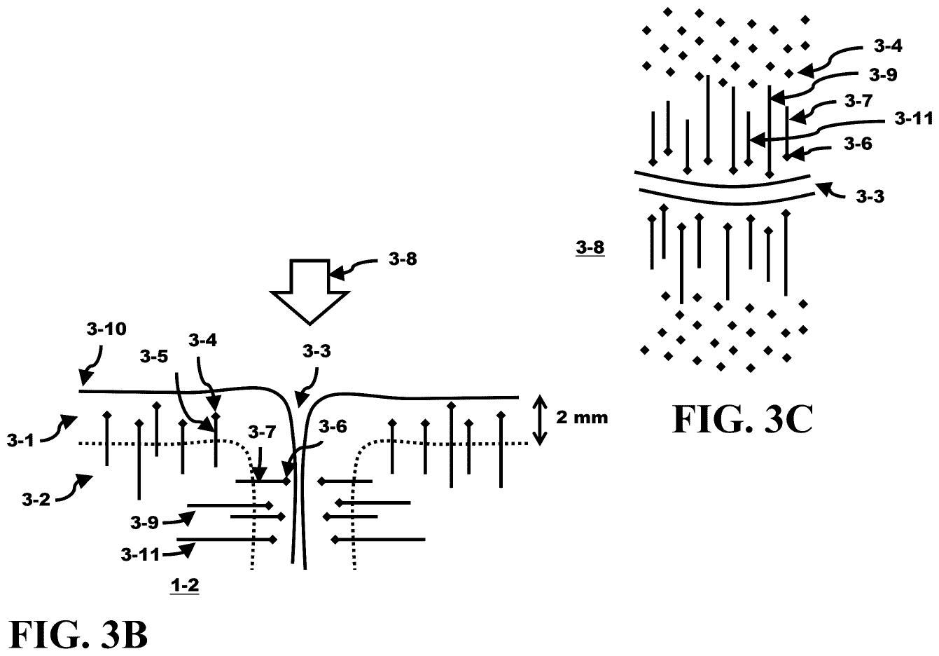

FIG. 18B presents the dashed rectangular region 1-3 that was highlighted in FIG. 1. These axons are located in the grey matter of the lateral fissure within the section of the brain highlighted by the white dashed rectangle 1-3 in FIG. 1. Within this region is a portion of the lateral fissure 1-1. Within the region 1-1 are the three axons 3-7, 3-9 and 3-11 that were shown to be lying horizontally or parallel to the surface of the brain within the grey matter of the brain in FIG. 3C.

In FIG. 18C, in one embodiment, the axons 3-7, 3-9, and 3-11 are grouped together as a unit 18-3. In another embodiment, these three axons represent the numerous axons that exist in this region. Note from FIG. 3B and FIG. 3C that the axons are located in a first dimension along the fold and along a second dimension deeper into the fold. The third dimension holds the lengths of the axons. The axons within the white area of the brain may or may not continue in a straight line pattern once they enter the grey area. Some of the axons may diverge from this path and may have sections that are orthogonal to the original path. Note also that the lengths of some of these axons may be much greater than the thickness of the white matter of the brain.

FIG. 18C expands on the antenna array concept of FIG. 18A further. Since the axons are shorter in the brain, the antenna elements 16-2 will be correspondingly shorter in length (see FIG. 17d). Thus, a larger amount of shorter antenna elements can exist in a given area over that of longer antenna elements. One embodiment of an antenna array 18-2 using shorter elements is illustrated in FIG. 18C. In one embodiment, the antennas can be positioned on the inside surface of a concave surface of a portion of a sphere-like shell. The inner radius of the shell substantially matches the outer radius of the human skull. The shell can be rotated along an axis that is perpendicular to the surface of the head; this way the antenna array can be orientated to have the antennas of the array excite other axons orientated along different directions within the brain. The energy of the electromagnetic energy is stimulating the neurons and axons within the fold of the lateral fissure (for example see FIG. 3B and FIG. 3C and the set of axons 3-7, 3-9 and 3-11, respectively). This entire volume of grey area being excited by the electromagnetic radiation may encompass millions of axons where the axons 3-7, 3-9 and 3-11 are a sub-set representation of the whole.

The antenna array 18-2 is driven by the transceiver array. In one embodiment, the transceiver array can be a single transceiver with adjustable phase components between the single transceiver and each of the antennas in the array. The adjustable phase components are adjusted to focus the beam on a given location. In another embodiment, each antenna can be coupled to its own transceiver. The adjustable phase components would be located before each of the transceivers. The near field electronic steering block would manage the adjustable phase components such that the modulated electromagnetic radiation emitted from the array would focus in on one volume of the brain. The electronic steering can also be used to systematically scan different adjacent areas of the brain and repeat the process over and over again. Thus, different sections of the brain can be studied. In the case of the embodiment where the array is within the spherical cap, the cap can be rotated along its axis to evaluate if different orientated axons exist within the same given volume. Secondly, a full 180° rotation can be evaluated to understand the effect of a complete reversal to the stimulus to the patient.

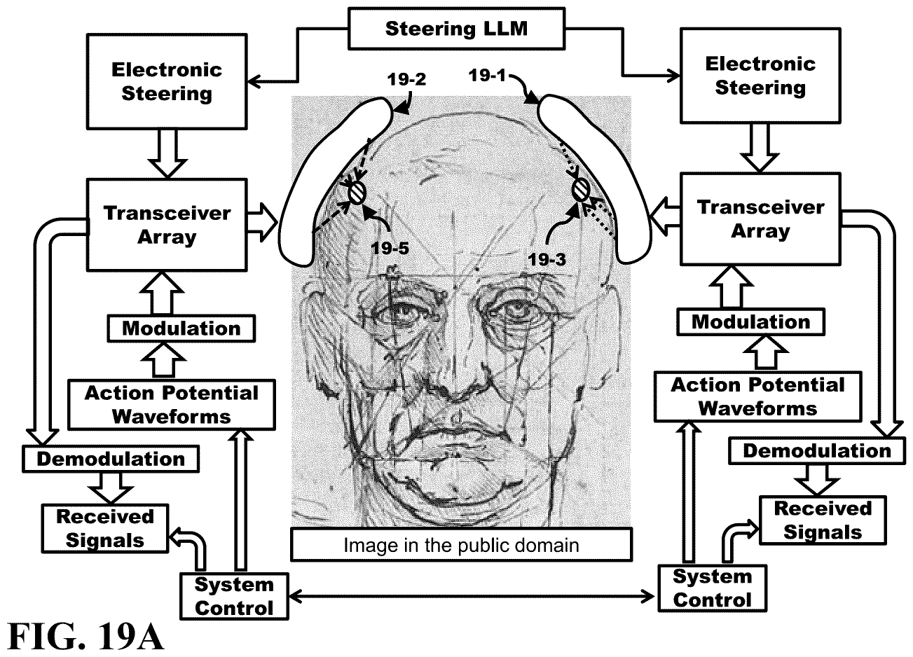

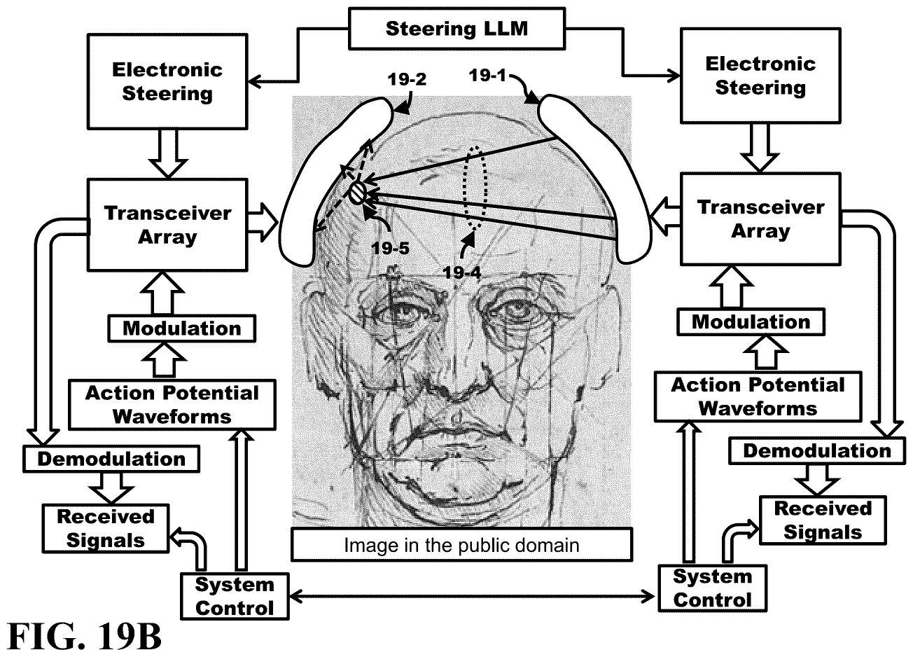

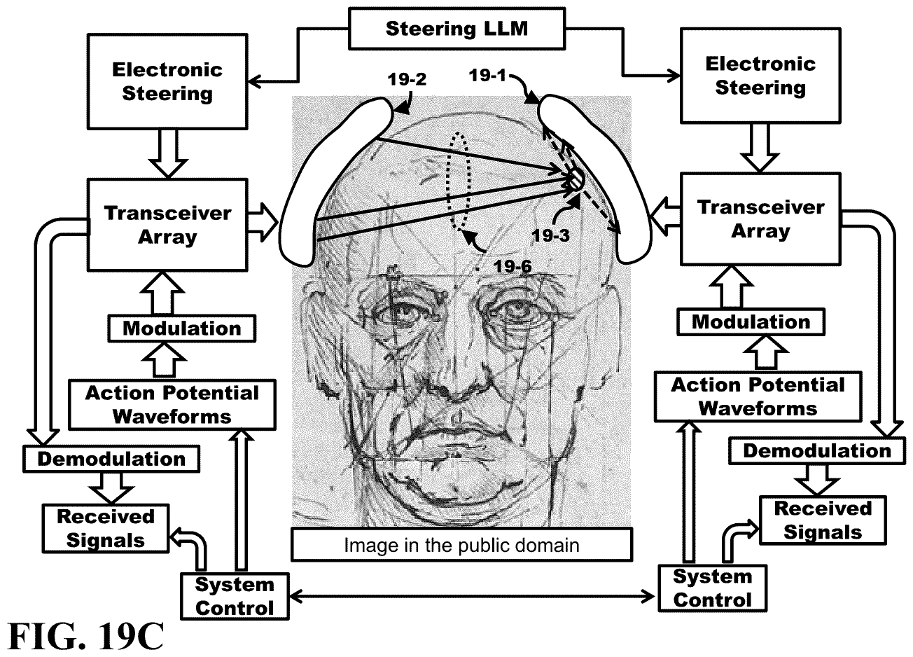

FIG. 19A illustrates a block diagram of a system that can stimulate axons and receive information from the brain using different sets of antenna arrays. The spherical-like shells surrounding the left 19-1 and right side 19-2 of the head are illustrated. In other embodiments, there can be less or more shells placed around the head.

In some embodiments, large language models (LLM) are utilized in performing the delivery and extraction of information in this particular Brain-Computer Interface (BCI). A LLM is used to help steering the electromagnetic radiation beam. This LLM can be trained used one of several ways. First, a living human head with transceivers placed within the brain using stents within the blood vessels of the brain. These stents contain the transceivers and can be placed in random locations. Then the system of FIG. 19A can be used to train the LLM to steer the beam accurately to the known random locations. The more volunteers offering their service enable a larger database which can then be used to further improve the accuracy of steering the beams through the skull and various regions of the brain till the beams converge at known locations. Then the LLM will be able to steer the beam to any location more accurately. Second, a realistic human model of the head can be manufactured. Then very small transceivers can be placed in duplicate models of these heads in random locations. These multiple heads can be tested using the system of FIG. 19A to improve the accuracy of steering the beam in near and far field conditions. Collecting all this data in a database forms the teaching models used to train the steering LLM so that the accuracy of beam steering can be improved. Third, cadavers of human heads can be used in place of the models mentioned earlier. The small transceivers can inserted with needles to prevent damaging the brain. Data can be collected and used to train the steering LLM as in the prior case.

Once the beams can be accurately steered to known locations within the brain with the help of the steering LLM, then the system control generates low frequency action potential waveforms. In one embodiment, these waveforms are amplitude modulated to the carrier wave frequency and applied to the transceiver array. In the case of studying the area 19-3 of the brain, the left shell 19-1 emits electromagnetic waves (EMW) in the near-field area 19-3 (dotted arrow lines). An analysis of the function for this area is evaluated according to the behavior of the subject. The left side of the brain controls language, speech and logical thinking. The subject is tested while repeating known phrases (for example, “Mary had a little lamb”) out loud to see there are any apparent changes to the individual. The entire volume of the language evaluation portion of the brain is scanned. The low frequency waveforms are modified in frequency from 1 to 100 Hz to see what effect this stimulus signal has on the performance of the individual. The shell can be rotated through a small angle and the same test can be performed. This process will continue until the shell has been rotated a full 360°. Then the carrier wave frequency fₒ can be increased slightly for several values for the entire set to be performed. Next the carrier wave frequency can be decreased below fₒ slightly for several values where the entire set of test are performed. At all times, the data is collected which will function as a database to train a transmitting LLM.

In another embodiment, these waveforms are amplitude modulated to the carrier wave frequency and applied to the transceiver array. In the case of studying the area 19-5 of the brain, the right shell 19-2 emits electromagnetic waves (EMW) in the near-field area 19-5 (dashed arrow lines). An analysis of the function for this area is evaluated according to the behavior of the subject. The right side of the brain controls special awareness, visual processing, and creative abilities. The subject is tested while reading known phrases from a book (for example, “1984”) out loud and asked questions about comprehending the various sentences to see there are any apparent changes to the individual. The entire volume of this portion of the brain is scanned. The low frequency waveforms are modified in frequency from 1 to 100 Hz to see what effect this stimulus signal has on the performance of the individual. The shell can be rotated through a small angle and the same test can be performed. This process will continue until the shell has been rotated a full 360°. Then the carrier wave frequency fₒ can be increased slightly for several values for the entire set to be performed. Next the carrier wave frequency can be decreased below fₒ slightly for several values where the entire set of test are performed. At all times, the data is collected which will function as a database to further train the transmitting LLM.

FIG. 19B illustrates another embodiment for testing the response of the human brain to excitation signals. In this embodiment, the left skull 19-1 generates far-field signals, within the oval 19-4 and excites the region on the opposite side of the brain 19-5 with the amplitude modulated signals that perform the best results (according to the behavior tests performed in FIG. 19A). The right side of the brain controls special awareness, visual processing, and creative abilities. The subject is tested while reading known phrases from a book (for example, “1984”) out loud and asked questions about comprehending the various sentences to see there are any apparent changes to the individual. The array of the shell 19-2 receives signals at the carrier wave frequency while the shell 19-2 is orientated orthogonally to the signals being applied in 19-4. Because the signals received by 19-2 are orthogonal to the signals of 19-4, their detection is minimized or zeroth out. The same excitation tests are applied to the shell 19-1 as those of FIG. 19A with the exception that as the shell 19-1 is rotated a delta, the shell 19-2 is also rotated the same delta to maintain orthogonality with the signal being emitted from shell 19-1. Thus, the shell 19-2 will receive the carrier wave signals corresponding to those axon segments that are behaving like a receiving antenna. The received energy is routed as current in the receiving segments of the axon that is aligned with the electric field of the EMW and when the induced current flows in the axon in paths that are octagonal to the receiving segments of the axons excited by the shell 19-1 an electromagnetic field is emitted that is orthogonal to the original incoming EMW.

FIG. 19C illustrates yet another embodiment for testing the response of the human brain to excitation signals. In this embodiment, the right skull 19-2 generates far-field signals, within the oval 19-6 and excites the region on the opposite side of the brain 19-3 with the amplitude modulated signals that perform the best results (according to the behavior tests performed in FIG. 19A). The left side of the brain controls language, speech and logical thinking. The subject is tested while repeating known phrases (for example, “Mary had a little lamb”) out loud to see there are any apparent changes to the individual. The array of the shell 19-1 receives signals at the carrier wave frequency while the shell 19-1 is orientated orthogonally to the signals being applied in 19-4. Because the signals received by 19-1 are orthogonal to the signals of 19-6, their detection is minimized or zeroth out. The same excitation tests are applied to the shell 19-2 as those of FIG. 19A with the exception that as the shell 19-2 is rotated a delta, the shell 19-2 is also rotated the same delta to maintain orthogonality with the signal being emitted from shell 19-2. Thus, the shell 19-1 will receive the carrier wave signals corresponding to those axon segments that are behaving like a receiving antenna. The received energy is routed as current in the receiving segments of the axon that is aligned with the electric field of the EMW and when the induced current flows in the axon in paths that are octagonal to the receiving segments of the axons excited by the shell 19-2 an electromagnetic field is emitted that is orthogonal to the original incoming EMW.

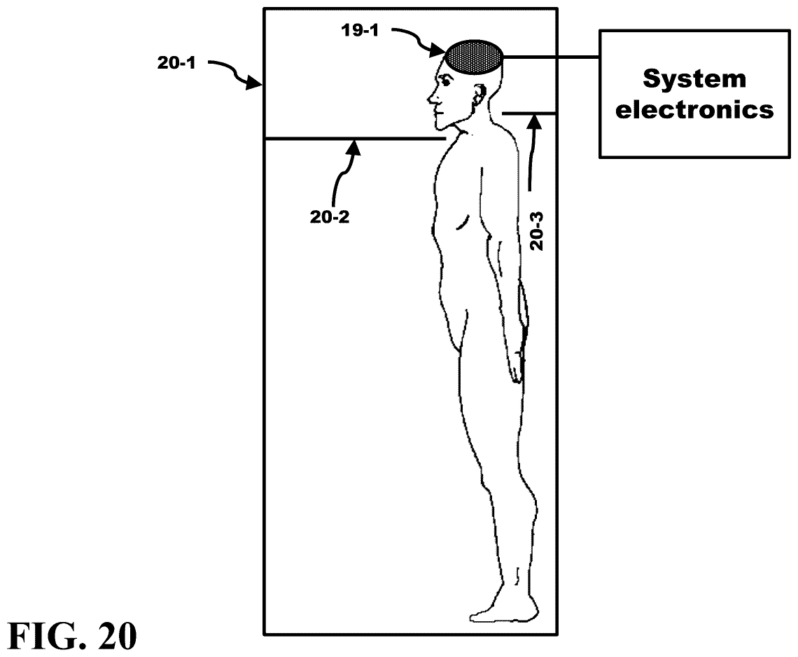

In one embodiment, FIG. 20 depicts a Faraday cage 20-1 surrounding a human with a shell 19-1 coupled to the subject's head. The Faraday cage isolates external signals from interfering with the signals entering and leaving the shell 19-1. In addition, in a second embodiment, additional internal shields 20-2 and 20-3 are used to prevent the electrical signals from the heart in interfering with signals entering and leaving the shell 19-1. In yet another embodiment, the systems electronics are located outside the Faraday cage. The signals to control, extract, introduce information from/to the antenna array are coupled via wires to the shell 19-1.

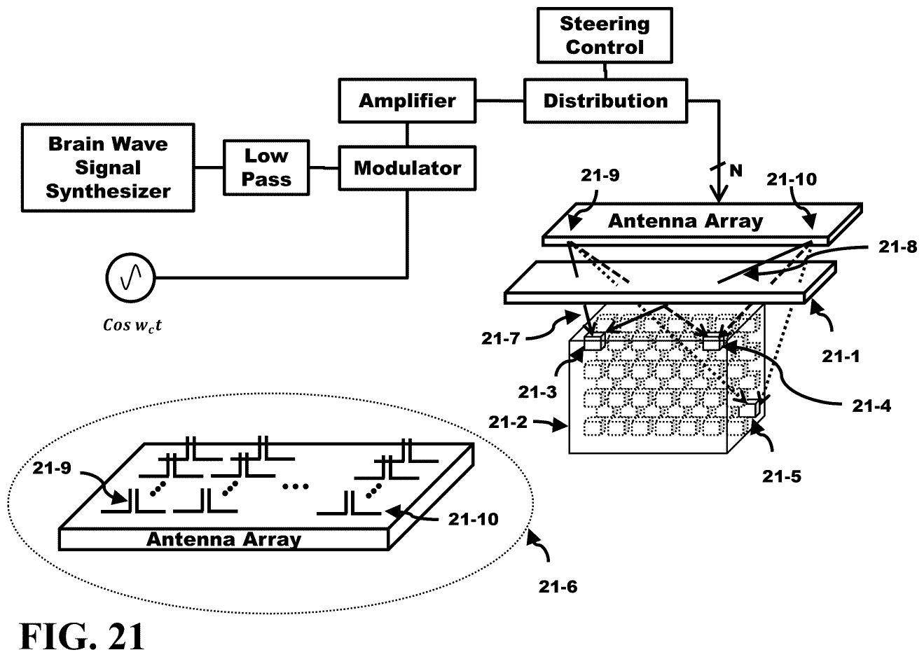

In one embodiment, FIG. 21 illustrates a block diagram of the driving electronics used to drive the EMW from the antenna array, through the skull 21-1, and into the brain matter 21-2. In one embodiment, the brain wave signal synthesizer generates action potential waveforms. The signal is passed through a low pass filter to remove any high frequency attributes. The modulator mixes the low frequency signal with an oscillator signal cos wet which is the carrier wave frequency. The signal is amplified and passed to the distribution block controlled by the steering control to adjust the timing (or phase) of the signals that need to be applied to each of the antennas in the antenna array to focus the energy to a given regional block of the brain.

FIG. 21 also provides one embodiment of the configuration of the physical placement of the antennas in the array illustrated in dotted oval 21-6. Two antennas 21-9 and 21-10 are indicated and are dipole antennas. Note in this embodiment, that all antennas in the array are aligned in the same direction.

The brain matter is represented by the rectanguloid 21-2 that is segregated into smaller regional blocks (for example, 21-3, 21-4, 21-5). The regional blocks adjoin (although not shown) one another. The antenna array is controlled by the steering control and the distribution block (and possibly a steering LLM) to control the beams from the plurality of antennas in the array to target each smaller block. The distribution block comprises adjustable delay elements that are inserted in the path between the amplifier and each of the antennas in the antenna array. These adjustable delay elements are adjusted by the steering control block to insure that a signal component generated by the amplifier arrives wirelessly from all of the antennas in the array at a given block of volume simultaneously. That is, that particular signal component arrives wirelessly at the given block of volume at the same time from all of the antennas in the array. Such an alignment of wireless signal is called a wave front. For example, the dipole antennas 21-9 and the one at 21-10 steer their signal to arrive simultaneously at the block 21-3. Simultaneously, all of the other antennas in the array (not shown) are targeting the block 21-3. Thus, block 21-3 is receiving the total energy of all the transmitting dipoles (as illustrated in the antennas at once and furthermore, the wave fronts for all of the wireless signals are aligned when they arrive at the block 21-3 so that their entire signal is added together). After a first time period, the steering control and distribution aligns the wireless signal to the next block to the right. This process continues until the last block 21-4 in the row is reached. Then, each of the blocks in the row below are sequentially targeted in the same manner. This continues until the lowest row is targeted. Once the first slice of the rectanguloid has been targeted, the system moves to the second slice which is just behind the first. This entire slice is targeted in the same manner as before unit the last blob 21-5 of the second slice has been targeted. In one embodiment, the process can be stopped or in another embodiment, the process can be repeated for a number of cycles. The path followed was in a row like scan for a slice and then the next slice was targeted. In other embodiments, other paths of flow through the rectanguloid volume may used. For example, each of the two adjacent blocks on the top two rows can be scanned, then the next two, until the entire top two rows have been scanned, then the next step would be to move to the next lower row and perform the same function. There are numerous paths that can be created and only two possibilities have been described.

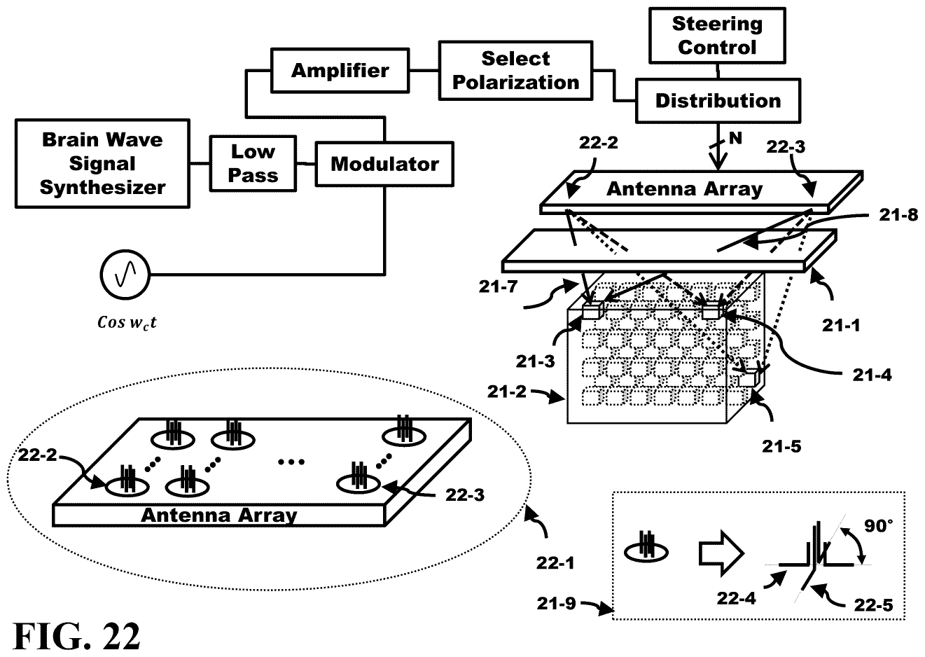

In one embodiment, FIG. 22 illustrates a block diagram of the driving electronics used to drive the EMW from the antenna array, through the skull 21-1, and into the brain matter 21-2. In one embodiment, the brain wave signal synthesizer generates action potential waveforms. The signal is passed through a low pass filter to remove any high frequency attributes. The modulator mixes the low frequency signal with an oscillator signal cos wet which is the carrier wave frequency. The signal is amplified and passed to the select polarization block and then to the distribution block controlled by the steering control to adjust the timing (or phase) of the signals that need to be applied to each of the antennas in the antenna array to focus the energy to a given regional block of the brain.

FIG. 22 also provides one embodiment of the configuration of the physical placement of the antennas in the array illustrated in dotted oval 22-1. Two antennas 22-2 and 22-3 are indicated and are a pair of dipole antennas that are octagonal to each other. See inset 21-9, the first of the pair of dipole antennas is 22-4. The second of the pair is the dipole antenna 22-5 that is orientated 90° from the first dipole antenna 22-4. Note in this embodiment, that all first of the pair of antennas in the array of 22-1 are aligned in the same direction.

The brain matter is represented by the rectanguloid 21-2 that is segregated into smaller regional blocks (for example, 21-3, 21-4, 21-5). The regional blocks adjoin (although not shown) one another. The antenna array is controlled by the steering control and the distribution block (and possibly a steering LLM) to control the beams from the plurality of antennas in the array to target each smaller block. A select polarization block can select one of the two different antennas 22-4 or 22-5 to stimulate the brain matter. The select polarization block can also select one antenna to stimulate the brain matter while the second of the pair can be used to sense the signal generated by the brain matter.

In one embodiment, the dipole antennas 22-2 and the one at 22-3 steer the signal of the first of their two dipoles to arrive simultaneously at the block 21-3. Simultaneously, all of the other antennas in the array (not shown) are targeting the block 21-3 in the same manner. Thus, block 21-3 is receiving the total energy of all the transmitting dipole (as illustrated in the antennas at once and furthermore, the wave fronts for all of the wireless signals are aligned when they arrive at the block 21-3 so that their entire signal is added together). After a first time period, the steering control and distribution aligns the wireless signal to the next block to the right. This process continues until the last block 21-4 in the row is reached. Then, each of the blocks in the row below are sequentially targeted in the same manner. This continues until the lowest row is targeted. Once the first slice of the rectanguloid has been targeted, the system moves to the second slice which is just behind the first. This entire slice is targeted in the same manner as before unit the last block 21-5 of the second slice has been targeted.

In another embodiment, the dipole antennas 22-2 and the one at 22-3 steer the signal of the second of their two dipoles to arrive simultaneously at the block 21-3. The second dipole is aligned 90° from that of the first. Simultaneously, all of the other antennas in the array (not shown) are targeting the block 21-3 in the same manner. Thus, block 21-3 is receiving the total energy of all the transmitting dipole (as illustrated in the antennas at once and furthermore, the wave fronts for all of the wireless signals are aligned when they arrive at the block 21-3 so that their entire signal is added together). After a first time period, the steering control and distribution aligns the wireless signal to the next block to the right. This process continues until the last block 21-4 in the row is reached. Then, each of the blocks in the row below are sequentially targeted in the same manner. This continues until the lowest row is targeted. Once the first slice of the rectanguloid has been targeted, the system moves to the second slice which is just behind the first. This entire slice is targeted in the same manner as before unit the last block 21-5 of the second slice has been targeted.

In yet another embodiment, the dipole antennas 22-2 and the one at 22-3 steer the signal of the first of their two dipoles to arrive simultaneously at the block 21-3. Simultaneously, the second of the two dipoles is receiving a signal from the brain matter. The second dipole is aligned 90° from that of the first. Simultaneously, all of the other antennas in the array (not shown) are targeting and/or receiving to/from the block 21-3 in the same manner. Thus, block 21-3 is receiving the total energy of all the first transmitting dipoles (as illustrated in the antennas at once and furthermore, the wave fronts for all of the wireless signals are aligned when they arrive at the block 21-3 so that their entire signal is added together). Simultaneously, the second dipole at 90° is receiving signals from the block 21-3. The receiver portion of the block diagram for this receiver portion of the system will be illustrated later. After a first time period, the steering control and distribution aligns the wireless signal to the next block to the right. This process continues until the last block 21-4 in the row is reached. Then, each of the blocks in the row below are sequentially targeted in the same manner. This continues until the lowest row is targeted. Once the first slice of the rectanguloid has been targeted, the system moves to the second slice which is just behind the first. This entire slice is targeted in the same manner as before unit the last block 21-5 of the second slice has been targeted.

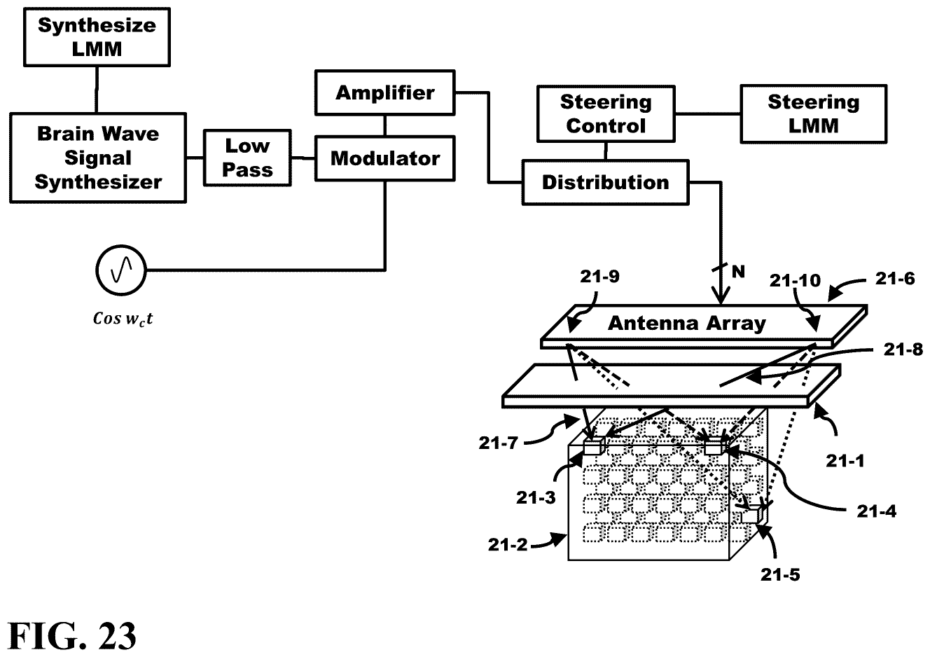

FIG. 23 is very similar to FIG. 21 except for the addition of the two blocks of the steering LMM and the synthesize LLM. The steering LLM and the synthesize LLM would use the data stored from the system that was described in FIG. 19A-C to train both LMMs. These LLMs will then help determine the best brain wave signals to generate and make the best choices in steering the beam when the array is used to excite the brain matter with EMW.

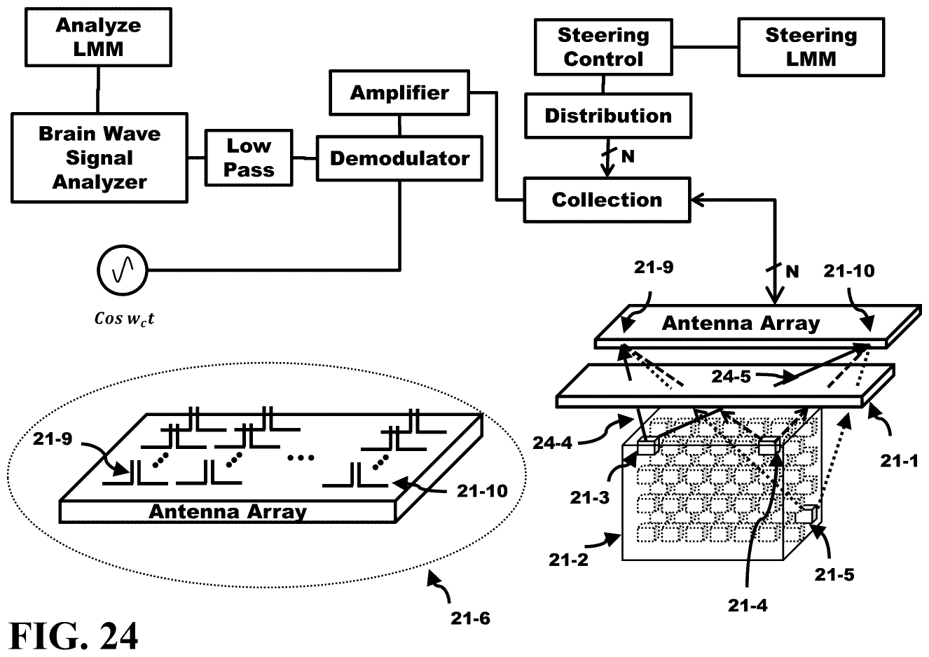

FIG. 24 illustrates a receiver system that collects data from the brain. The steering LLM, Steering Control, and distribution blocks introduce the correct delay or phase into each of the paths that are being collected from the different antennas in the array.

FIG. 24 also provides one embodiment of the configuration of the physical placement of the antennas in the array illustrated in dotted oval 21-6. Two antennas 21-9 and 21-10 are indicated and are dipole antennas. Note in this embodiment, that all antennas in the array are aligned in the same direction.

The brain matter is represented by the rectanguloid 21-2 that is segregated into smaller regional blocks (for example, 21-3, 21-4, and 21-5). The regional blocks adjoin (although not shown) one another. The antenna array is controlled by the steering control, the distribution block, a steering LLM through the collection block to adjust the receive beams from the plurality of antennas in the array so they align from each of the smaller blocks. For example, the dipole antennas 21-9 and the one at 21-10 receive their signal from the block 21-3 via paths 24-4 and 24-5. Simultaneously, all of the other antennas in the array (not shown) are receiving information from the block 21-3. Thus, block 21-3 is provides the total energy of all the receiving dipoles (as illustrated in the antennas at once and furthermore, the wave fronts for all of the wireless signals from the block 21-3 are aligned when they arrive at the collection block so that their entire signal is added together.) After a first time period, the steering control and distribution aligns the received wireless signal to the next block to the right. This process continues until the last block 21-4 in the row is reached. Then, each of the blocks in the row below are sequentially received in the same manner. This continues until the lowest row is received. Once the first slice of the rectanguloid has been received, the system moves to the second slice which is just behind the first. This entire slice is received in the same manner as before unit the last block 21-5 of the second slice has been received. In one embodiment, the process can be stopped or in another embodiment, the process can be repeated for a number of cycles. The path followed was in a row like scan for a slice and then the next slice was received. There are numerous paths that can be created and only one possibility have been described.

Once the received signals are aligned, at the collection block, the amplifier amplifies the signal. The incoming signal is mixed with the carrier wave signal cos w_{c}t to demodulate the signal and extract the lower frequency signal of the action potential. The signal is passed through a low pass filter to clean the signal. The analyze LLM trained from the data collected from the system described in FIG. A-C is use to analyze the received signal.

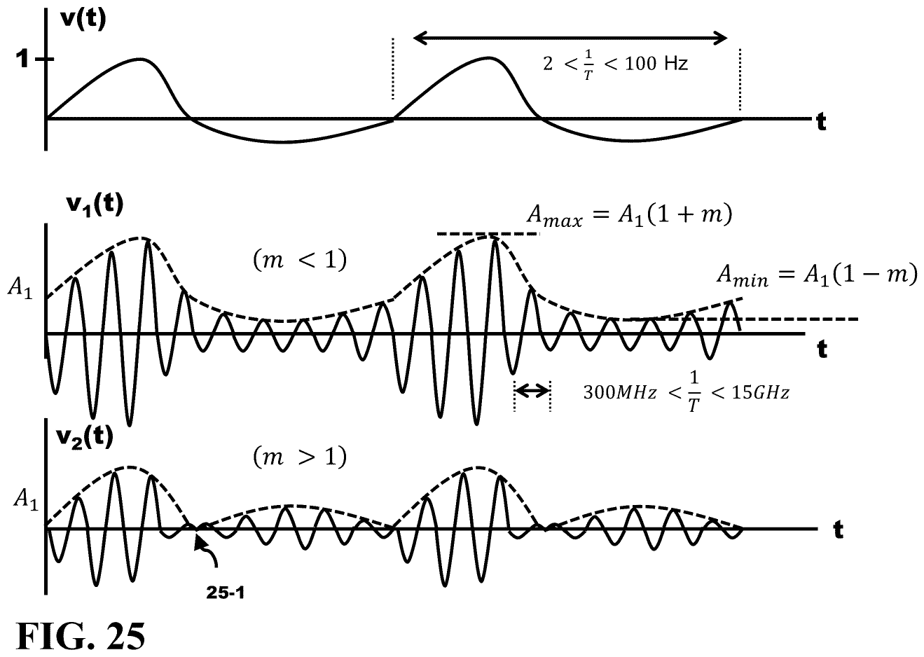

FIG. 25 illustrates the waveforms for an amplitude modulated signal. The top waveform v(t) is a repetitive brain signal. The frequency ranges from 2 Hz to 100 Hz. In this embodiment, the waveform is very similar to the action potential waveform. In other embodiments, other types of waveforms may be synthesized. The v(t) is used to modulate the carrier wave signal. In one embodiment, the carrier wave signal can have a frequency of 300 MHz to 15 GHz. The v₁ (t) signal in the middle waveform show the carrier wave signal after being modulated by the v(t) signal. The modulation index, m, is less than one. The waveform v₂ (t) in the lowest waveform illustrates the waveform when the modulation index is greater than 1. The phase of the signal is inverter at 25-1.

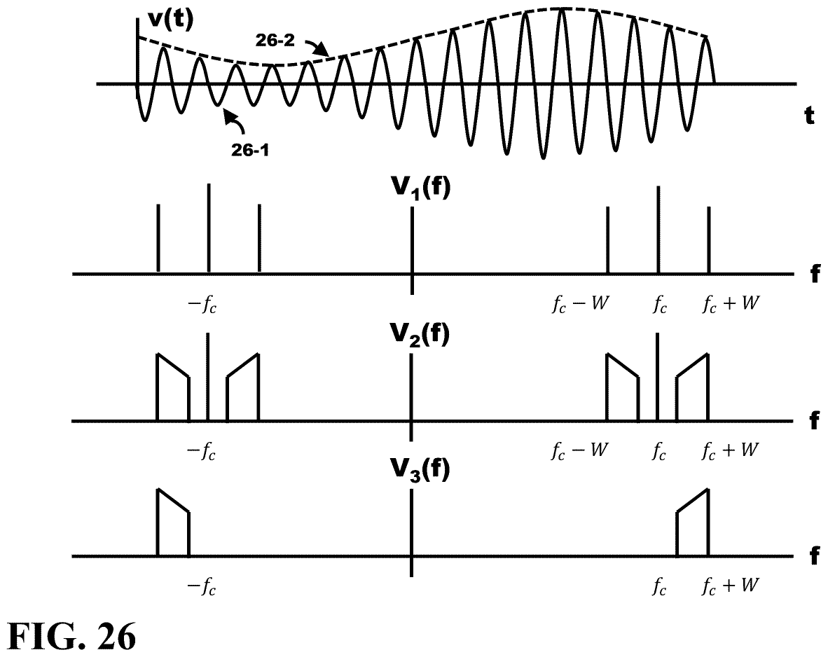

FIG. 26 shows an amplitude modulated signal. The carrier wave frequency f_{c} 26-1 is modulated by the lower frequency signal 26-2 producing the waveform v(t). The waveform V₁ (f) shows the frequency spectrum when the signal 26-2 is a slower frequency sinusoidal. The frequency spectrum shows a line for the carrier wave frequency fc and spectrum lines at f_{c}-W and f_{c}+W where W is the frequency of the signal 26-2.

When the carrier wave frequency is modulated by the signal 26-2 where this signal is a bandwidth limited signal, the frequency spectrum is shown as V₂ (f). The low frequency bandwidth limited signal generates two side bands within the frequencies f_{c}-W and f_{c}+W where W is the bandwidth of the modulating signal.

The frequency spectrum signal V₃(f) is arrived at when the frequency spectrum is filtered to remove the lower side band and the energy of the carrier wave frequency. This filtering lowers the power content of the amplitude modulated signal. This is advantageous when introducing this signal into the brain in order that heating is minimized.

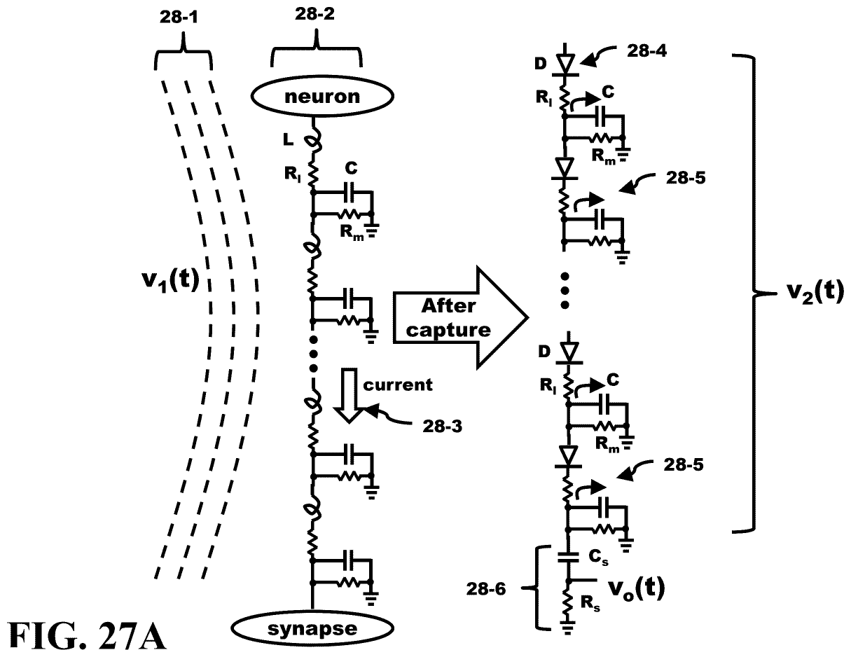

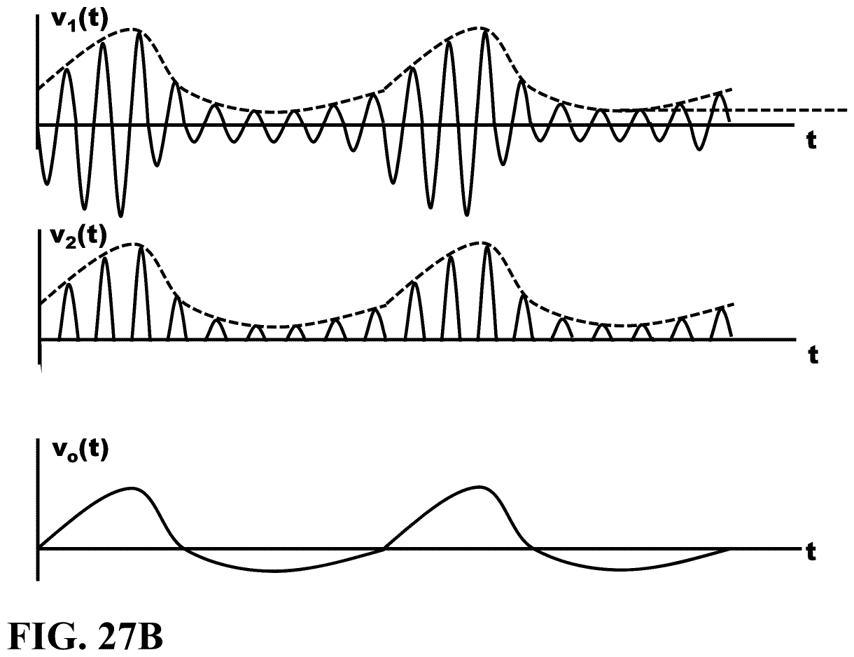

FIGS. 27A-B illustrates how an impinging amplitude modulated signal v₁(t) 28-1 interacts with the electrical equivalent circuit of an axon 28-2. The neuron is located at the top of the model and the synapse is at the bottom of the model. Current 28-3 within the axon is known to flow from the neuron to the synapse. It is as though a diode exists in the model of the axon conductor. The waveform v₁(t) is illustrated at the top of FIG. 27B. The axon is electrically modelled as a leaky antenna 28-2 since the tube-like structure of the axon (see FIG. 13B) has characteristics of conducting wire. Secondly, since the carrier wave frequency of the amplitude modulated signal is matched to the antenna length of the axon, the possibility of the axon intercepting the carrier wave frequency becomes possible. Once the electrical equivalent model of the axon captures the energy of the electromagnetic signal, the diode 28-4 behavior of the axon kicks in and causes the negative portion of the signal to clamp the voltages to ground by passing this current to ground 28-5 via the capacitance C in the model. The waveform across the axon now appears as v₂(t) in FIG. 27B. The synapse is modelled as a low pass filter 28-6 causing the signal vₒ(t) to be extracted out the signal v₂(t). The lower signal in FIG. 27B is the signal vₒ(t). This signal is applied millions of times in the volume across the synapse where observations as described in FIGS. 13A-C may be noted.

The amplitude modulated signal which is delivered to the brain is tailored to be captured by the axon by matching its length to the wavelength of the carrier wave frequency. The very nature of the axon further filters the signal to clamp the negative portion of the signal. While the synapse having an low pass filter characteristic filter out the modulating signal from the carrier wave frequency. The neuron-axon-synapse structure behaves as a demodulator to an amplitude modulated signal when the carrier wave frequency of the signal optimally matches the length of the axon.

Finally, it is understood that the above description are only illustrative of the principles of the current invention. It is understood that the various embodiments of the invention, although different, are not mutually exclusive. In accordance with these principles, those skilled in the art may devise numerous modifications without departing from the spirit and scope of the invention.

What is claimed is:

1. An axon-synapse activation apparatus comprising:
an antenna, wherein said antenna has a first length;
a transceiver coupled to said antenna;
a modulator, wherein an information signal modulates a carrier wave generating a modulated signal, wherein a wavelength of said carrier wave is optimized to match said first length of said antenna;
an axon having a second length, wherein a first end of said axon is coupled to a neuron via a synapse; and
an output of said modulator couples said modulated signal to said antenna, wherein said axon wirelessly captures from said antenna said modulated signal along its said second length, wherein said axon and said synapse demodulate said modulated signal to extract said first information, and wherein said information signal is applied as an input stimulus to said neuron to activate said neuron.

2. The apparatus of claim 1, wherein
said neuron is in the brain of a human, wherein said activated neuron produces a response in said human.

3. The apparatus of claim 1, wherein
said information signal is an action potential.

4. The apparatus of claim 1, wherein
said wavelength of said carrier wave optimally matches said second length of said axon.

5. The apparatus of claim 1, wherein
said antenna is orientated substantially parallel to said axon.

6. The apparatus of claim 5, wherein
said axon is in a near-field electromagnetic radiation relationship to said antenna.

7. The apparatus of claim 1, wherein
said information signal amplitude modulates said carrier wave.

8. The apparatus of claim 1, further comprising:
an amplifier to amplify said modulated signal before being applied to said antenna.

9. An axon-synapse activation apparatus comprising:
an axon having a length; wherein a first end of said axon is coupled to a neuron via a synapse, wherein said axon wirelessly captures along its said length an amplitude modulated electromagnetic signal modulated by an information signal, wherein said axon and said synapse demodulate said amplitude modulated electromagnetic signal to extract said information signal, and wherein said information is applied as an input stimulus to said neuron via said synapse to activate said neuron.

10. The apparatus of claim 1, wherein
said neuron is in the brain of an animal, wherein said activated neuron produces a response in said animal.

11. The apparatus of claim 1, wherein
said information signal is an action potential.

12. The apparatus of claim 1, further comprising:
an antenna, wherein said antenna has a first length;
a transceiver coupled to said antenna; and
a modulator, wherein said information signal modulates a carrier wave generating a modulated signal, wherein a wavelength of said carrier wave is optimized to match said first length of said antenna.

13. The apparatus of claim 12, wherein
said wavelength of said carrier wave optimally matches said length of said axon.

14. The apparatus of claim 12, wherein
said antenna is orientated substantially parallel to said axon.

15. The apparatus of claim 14, wherein
said axon is in a near-field electromagnetic radiation relationship to said antenna.

16. The apparatus of claim 12, wherein
said information signal amplitude modulates said carrier wave.

17. The apparatus of claim 12, further comprising:
an amplifier to amplify said modulated signal before being applied to said antenna.

18. An axon-synapse activation apparatus comprising:
a plurality of axons each having substantially a same first length; wherein a first end of said axons are each coupled to a neuron via a synapse, wherein said axons wirelessly capture along its said first length an amplitude modulated electromagnetic signal modulated by an information signal, wherein said axons and said synapses each demodulate said amplitude modulated electromagnetic signal to extract said information signal, and wherein said information is applied as an input stimulus to said coupled neuron via said synapse to activate its corresponding said neuron.

19. The apparatus of claim 18, wherein
each said neuron is in the brain of an animal, wherein each said activated neuron together produces a response in said animal.

20. The apparatus of claim 19, wherein
said animal is a human.
